(19) United States
(12) Patent Application Publication
(10) Pub. No.: US 2023/0179723 A1
(43) Pub. Date: Jun. 8, 2023

(54) INFORMATION PROCESSING APPARATUS THAT WIRELESSLY COMMUNICATES WITH EXTERNAL APPARATUS, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventors: Katsunari Suzuki, Kanagawa (JP); Yoshikazu Sato, Chiba (JP)

(21) Appl. No.: 17/982,650

(22) Filed: Nov. 8, 2022

(30) Foreign Application Priority Data
Dec. 7, 2021 (JP) 2021-198638
Dec. 7, 2021 (JP) 2021-198639
Apr. 6, 2022 (JP) 2022-063498
Sep. 6, 2022 (JP) 2022-141641

(51) Int. Cl. H04N 1/00

(52) U.S. Cl. CPC H04N 1/00896; H04N 1/00204; H04N 1/00411; H04N 1/00899; H04N 2201/0094; H04N 2201/0072

(57) ABSTRACT

An information processing apparatus that reduces power consumption using IEEE802.11ah connection without spoiling usability of wireless communication. The information processing apparatus includes a memory device that stores instructions, and a processor that executes the instructions to wirelessly communicate with an external apparatus by at least one of a first communication function that wireless communicates by a first wireless communication method that conforms to IEEE802.11ah and a second communication function that wirelessly communicates by a second wireless communication method of which a communication speed is higher than that of the first wireless communication method, determine whether an electric power state of the apparatus is a second electric power state in which power consumption is lower than a first electric power state, and prompt a user to set switching setting that stops the second communication function and starts the first communication function in the second electric power state.

### BACKGROUND OF THE INVENTION

### Field of the Invention

The present invention relates to an image processing apparatus that wirelessly communicates with an external apparatus, a control method therefor, and a storage medium storing a control program therefor.

### Description of the Related Art

In recent years, a scheme called “IoT (Internet of Things)” that connects various devices exceeding 50 billion to the Internet is beginning to spread. In the IoT, various wireless standards for connecting devices to the Internet (for example, see Japanese Laid-Open Patent Publication (Kokai) No. 2003-299141 (JP 2003-299141A)). There is IEEE802.11ah (hereinafter referred to as “11ah”, simply) as one of the wireless standards. The 11ah is characterized in that electric power consumption for communication is lower than that of conventional WiFi standards. Accordingly, it is assumed that an image forming apparatus (an image processing apparatus) like an MFP (Multifunction Peripheral/Product/Printer) employs the 11ah in order to reduce electric power consumption for communication.

In the meantime, the 11ah is low in throughput and is not fit for transfer of large capacity data. For example, the 11ah is used in a power saving mode (a sleep state, for example), which does not need high-speed wireless communication, and is switched to another wireless standard that achieves high-speed communication in a standby state that needs high-speed communication. This enables reduction of the electric power consumption without spoiling usability of the wireless communication.

However, a conventional image forming apparatus does not have a means to notify a user that reduction of electric power consumption can be achieved using such a switch function. Accordingly, reduction of electric power consumption using the 11ah according to a user's instruction without spoiling the usability of the wireless communication cannot be attained.

### SUMMARY OF THE INVENTION

The present invention provides an information processing apparatus, a control method therefor, and a storage medium storing a control program therefor, which can achieve reduction of electric power consumption using the 11ah connection according to a user's instruction without spoiling usability of wireless communication.

Accordingly, an aspect of the present invention provides an information processing apparatus including a memory device that stores a set of instructions, and at least one processor that executes the set of instructions to wirelessly communicate with an external apparatus by at least one of a first communication function that wireless communicates by a first wireless communication method that conforms to IEEE802.11ah and a second communication function that wirelessly communicates by a second wireless communication method of which a communication speed is higher than that of the first wireless communication method, determine whether an electric power state of the information processing apparatus is a second electric power state in which electric power consumption is lower than a first electric power state, and prompt a user to set switching setting that stops the second communication function and starts the first communication function in the second electric power state.

According to the present invention, reduction of electric power consumption using the 11ah according to a user's instruction without spoiling the usability of the wireless communication can be attained.

Further features of the present invention will become apparent from the following description of exemplary embodiments with reference to the attached drawings.

### BRIEF DESCRIPTION OF THE DRAWINGS

FIG. 1 is a view showing a connecting relation of a network of an entire wireless communication system.

FIG. 2 is a view showing a relation among a sequence of the entire wireless communication system, an electric power state of an image forming apparatus, and a wireless LAN connection state between the image forming apparatus and an access point.

FIG. 3 is a block diagram showing the image forming apparatus.

FIG. 4A and FIG. 4B are schematic views showing states of blocks of the image forming apparatus in respective operating states.

FIG. 5 is a block diagram showing the access point.

FIG. 6 is a block diagram showing a terminal processing apparatus.

FIG. 7 is a block diagram showing a wireless LAN module.

FIG. 8A through FIG. 8H are views showing screen examples displayed concerning wireless LAN connection of the image forming apparatus.

FIG. 9 is a view showing a boot sequence of the image forming apparatus.

FIG. 10 is a view showing a sequence of a wireless LAN module initialization process.

FIG. 11 is a view showing a shifting-to-sleep sequence of the image forming apparatus.

FIG. 12A through FIG. 12C are views showing screen examples displayed concerning a sleep state and a standby state.

FIG. 13 is a view showing a sequence of a first wireless connection switching process.

FIG. 14 is a view showing a returning-to-standby sequence of the image forming apparatus.

FIG. 15 is a view showing a sequence of a second wireless connection switching process.

FIG. 16A through FIG. 16C are views showing examples of switching setting screens for wireless LAN connection in the sleep state.

FIG. 17 is a flowchart showing a procedure of a wireless-LAN-connection setting process executed by the image forming apparatus in FIG. 1 in the sleep state.

FIG. 18A through FIG. 18D are views showing screen examples concerning the wireless LAN connection of the image forming apparatus in the sleep state.

FIG. 19 is a view showing a relation among a sequence of an entire wireless communication system, which includes an image forming apparatus as an information processing apparatus in a second embodiment, an electric power state of the image forming apparatus, and a wireless LAN connection state between the image forming apparatus and an access point.

FIG. 20A through FIG. 20C are schematic views showing states of blocks of the image forming apparatus in the second embodiment in respective operating states.

FIG. 21 is a view showing a shifting-to-sleep sequence of the image forming apparatus in the second embodiment.

FIG. 22A through FIG. 22D are views showing screen examples concerning a sleep state and a standby state of the image forming apparatus in the second embodiment.

FIG. 23 is a view showing a sequence of a third wireless connection switching process.

FIG. 24 is a view showing a returning-to-standby sequence of the image forming apparatus in the second embodiment.

FIG. 25 is a view showing a sequence of a fourth wireless connection switching process.

FIG. 26 is a view showing a job execution sequence of the image forming apparatus in the standby state.

FIG. 27A and FIG. 27B are views describing a means for determining whether communication of the job in the fourth wireless connection switching process is connected by either the 11ah connection or the 11ac connection.

FIG. 28 is a table showing a relation between a sleep electric power setting, a shifting-to-sleep speed, registration of the 11ac connection, and WiFi connection in shifting to the sleep state.

FIG. 29 is a table describing a connection state of a transmission source in receiving a job and a connection state in executing the job.

### DESCRIPTION OF THE EMBODIMENTS

Hereafter, embodiments according to the present invention will be described in detail by referring to the drawings. However, a configuration described in the following embodiments is just an example, and the scope of the present invention is not limited to the configuration described in the embodiments.

First, an information processing apparatus and its control method according to a first embodiment of the present invention will be described.

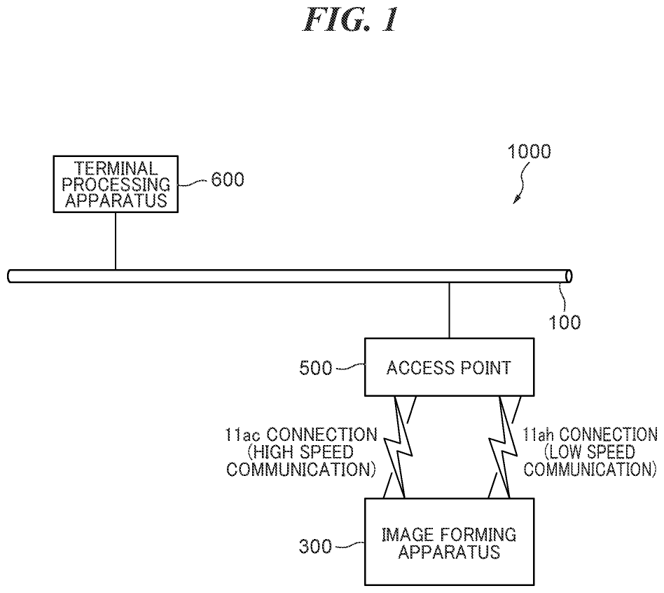

FIG. 1 is a view showing a connecting relation of a network of an entire wireless communication system. The wireless communication system 1000 shown in FIG. 1 is provided with an image forming apparatus 300 as an information processing apparatus of the present invention, an access point 500, and a terminal processing apparatus 600 as a portable communication terminal.

The terminal processing apparatus 600 and access point 500 are connected to a network 100. Thereby, the terminal processing apparatus 600 and access point 500 becomes mutually communicable. It should be noted that the terminal processing apparatus 600 and access point 500 may be connected to the network 100 through a wired LAN or a wireless LAN.

The image forming apparatus 300 is a printer, a copying machine, a facsimile machine, or a multifunction peripheral (MFP), for example. The information processing apparatus to which the present invention is applied is not limited to the image forming apparatus 300. The image forming apparatus 300 and the access point 500 that is its external apparatus are connected to be communicable through the wireless LAN.

As mentioned later, the image forming apparatus 300 has a first communication function that achieves wireless communication by a first wireless communication method based on IEEE802.11ah and a second communication function that achieves wireless communication by a second wireless communication method of which a communication speed is higher than that of the first wireless communication method. In the meantime, the access point 500 also has the first communication function and second communication function as with the image forming apparatus 300. Then, the image forming apparatus 300 and access point 500 are wirelessly communicable mutually by at least one of the first communication function and second communication function.

Wireless frequency of the second wireless communication method is 1 GHz or more. For example, the second wireless communication method conforms to one of standards of IEEE802.11a/b/g/n/ac/ax. Thereby, the communication speed of the second communication function is sufficiently higher than that of the first wireless communication method of which wireless frequency is less than 1 GHz.

It should be noted that the second wireless communication method is based on IEEE802.11ac that is selected from among IEEE802.11a/b/g/n/ac/ax in this embodiment. Hereinafter, the wireless communication connection by the first communication function may be called “11ah connection”. The wireless communication connection by the second communication function may be called “11ac connection”.

Moreover, electric power consumption of the image forming apparatus 300 and access point 500 in wirelessly communicating by the first communication function is lower than electric power consumption of them in wirelessly communicating by the second communication function. Thereby, the electric power consumption of the wireless communication by the first communication function is reduced.

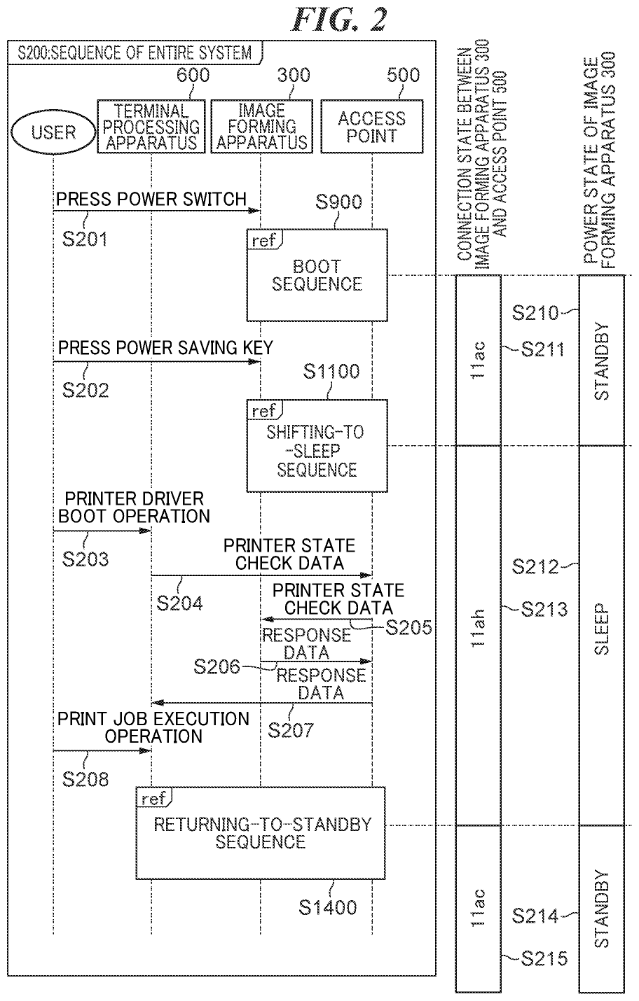

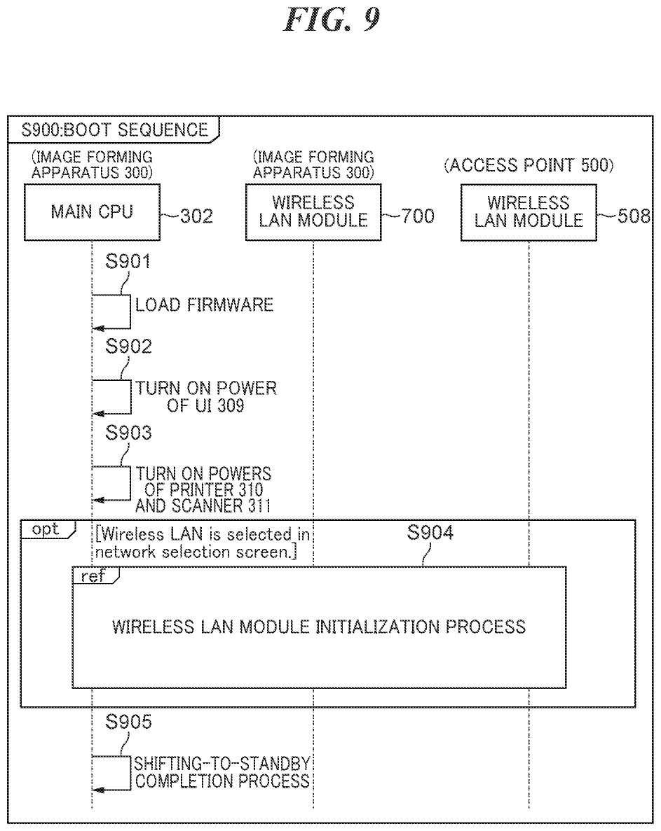

FIG. 2 is a view showing a relation among a sequence of the entire wireless communication system, an electric power state of the image forming apparatus, and a wireless LAN connection state between the image forming apparatus and access point. It should be noted that FIG. 2 shows a case where the image forming apparatus 300 prints out as an example. As shown in FIG. 2, a user presses a power switch of the image forming apparatus 300 in a step S201 to boot the image forming apparatus 300 from an OFF state to an ON state. A boot sequence is started by a trigger that is the press of this power switch. The boot sequence S900 is mentioned later by referring to FIG. 9.

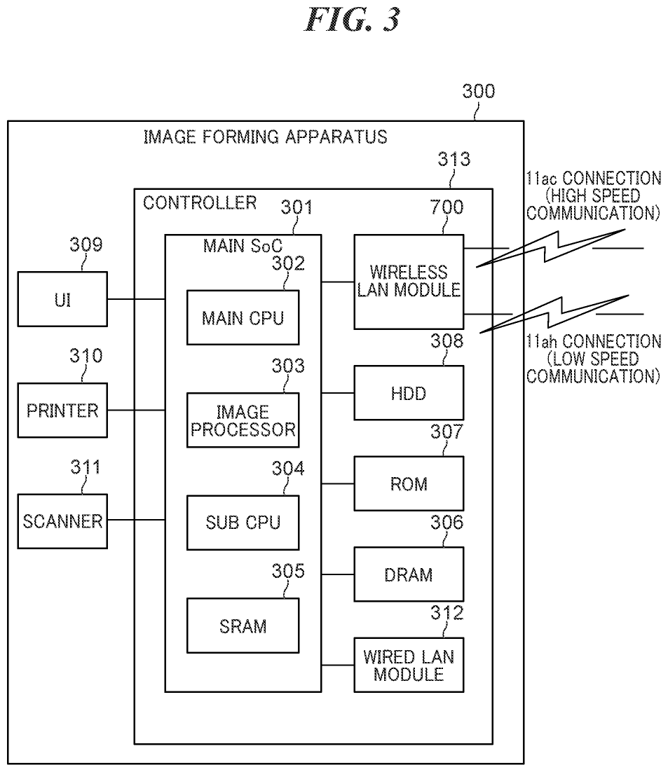

When the boot sequence S900 is completed, the electric power state of the image forming apparatus 300 turns into a standby state in a step S210. The standby state is the electric power state in which the components, such as a printer (a printing unit) 310 and a scanner (a reading unit) 311 shown in FIG. 3 mentioned later, of the image forming apparatus 300 are operatable. At this time, the wireless LAN connection state of the image forming apparatus 300 is controlled by the 11ac connection (i.e., the wireless communication connection of the second communication function) in a step S211 in order to attain a high communication speed by giving priority to the communication speed of the image forming apparatus 300. Thereby, quick wireless communication becomes available in a case where image data that the printer 310 prints is received from an external apparatus or in a case where image data that the scanner 311 reads and generates is sent to the external apparatus.

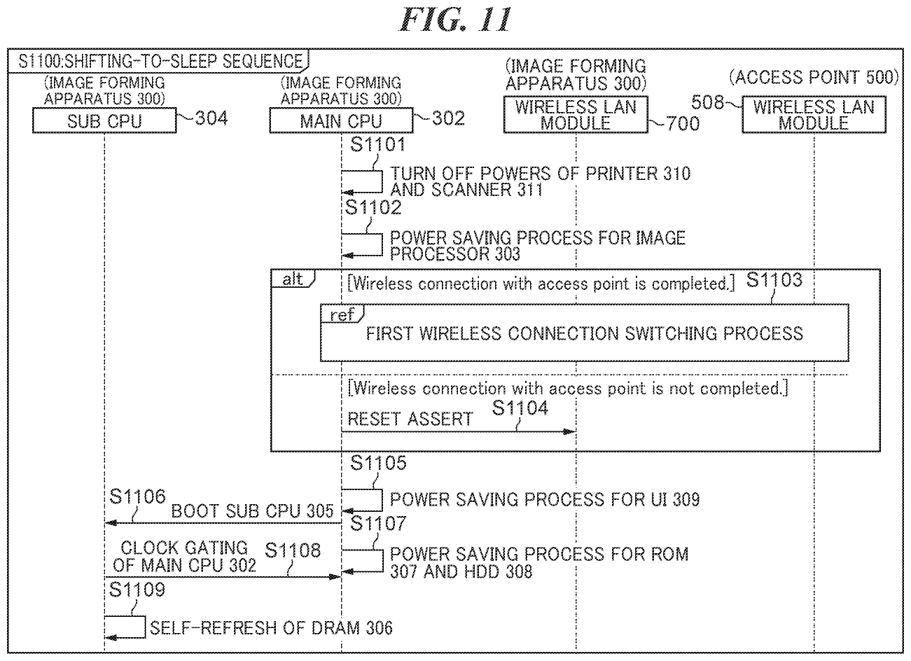

In a step S202, the user presses a power saving key provided in a UI (user interface) 309 of the image forming apparatus 300 in order to shift the image forming apparatus 300 to a sleep state. A shifting-to-sleep sequence S1100 is started by a trigger that is the press of this power saving key. The shifting-to-sleep sequence S1100 is mentioned later by referring to FIG. 11. When the shifting-to-sleep sequence S1100 is completed, the electric power state of the image forming apparatus 300 turns into the sleep state in a step S212.

In the sleep state, some components, such as the printer 310 and scanner 311 mentioned later, of the image forming apparatus 300 are in a power saving state. At this time, the wireless LAN connection state of the image forming apparatus 300 is controlled by the 11ah connection (i.e., the wireless communication connection of the first communication function) in a step S213 by giving priority to reduction of electric power consumption (power saving) of the image forming apparatus 300. Thereby, the electric power consumption of the image forming apparatus 300 is reduced as compared with the case of the 11ac connection state of the wireless LAN while keeping the connection state of wireless LAN.

In a step S203, the user operates the terminal processing apparatus 600 to start a printer driver in order to control the image forming apparatus 300 to print out. It should be noted that an IP address of the image forming apparatus 300 shall be beforehand registered into the printer driver in this embodiment.

In a step S204, the terminal processing apparatus 600 transmits inquiry data (printer state check data) to the IP address of the image forming apparatus 300. In a step S205, the image forming apparatus 300 receives the inquiry data through the access point 500.

In a step S206, the image forming apparatus 300 transmits data showing a printable state as a response to the data received in the step S205 to the access point 500. In a step S207, the terminal processing apparatus 600 receives this data through the access point 500.

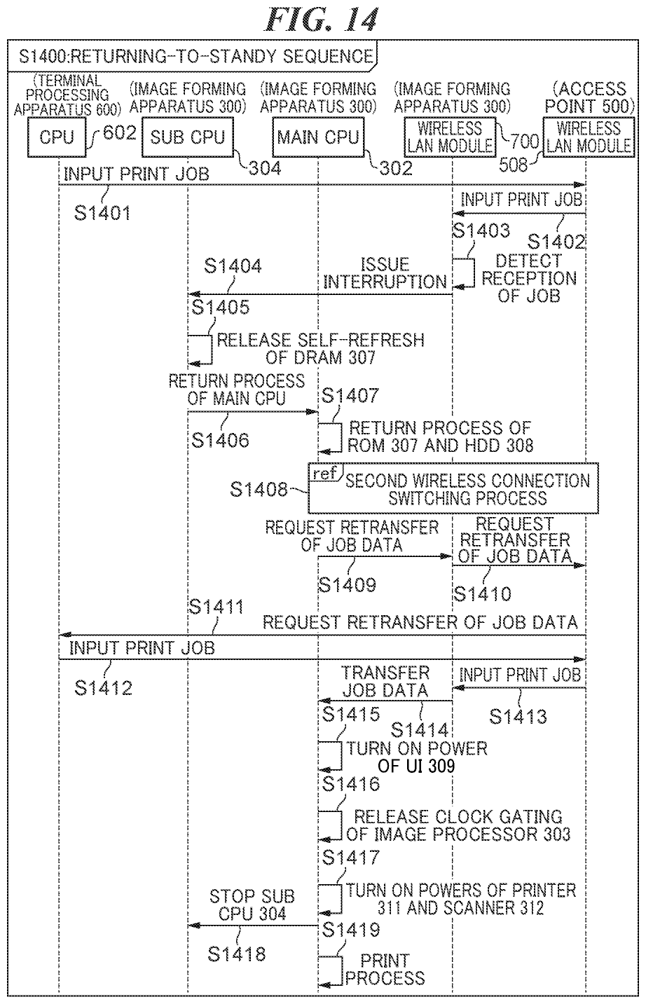

In a step S208, the user operates the terminal processing apparatus 600 to execute a print job in order to control the image forming apparatus 300 to print out. A returning-to-standby sequence S1400 is started by a trigger that is the input of the print job to the image forming apparatus 300 in the sleep state. The returning-to-standby sequence S1100 is mentioned later by referring to FIG. 14.

When the image forming apparatus 300 detects job reception in the returning-to-standby sequence S1400, the electric power state of the image forming apparatus 300 turns into the standby state in a step S214. At this time, the image forming apparatus 300 switches the wireless LAN connection state to the 11ac connection state in a step S215 in order to attain a high communication speed by giving priority to the communication speed. As mentioned above, the image forming apparatus 300 switches the wireless LAN connection state suitably in accordance with the electric power state.

FIG. 3 is a block diagram showing the image forming apparatus 300. As shown in FIG. 3, the image forming apparatus 300 has a controller 313, the UI 309, the printer 310, and the scanner 311. The controller 313 has a main SoC (System on a Chip) 301, a DRAM 306, a ROM 307, an HDD 308, a wired LAN module 312, and a wireless LAN module 700.

The main SoC 301 is an integrated circuit component (a computer) and includes a main CPU 302, an image processor 303, a sub CPU 304, and an SRAM 305 in this embodiment. The main CPU 302 is a CPU for controlling the entire image forming apparatus 300. The image processor 303 applies image processes, such as correction, processing, and edit, to input image data read by the scanner 311.

Moreover, the image processor 303 applies a color conversion process, a filtering process, a resolution conversion process, etc. to output image data output to the printer 310. The sub CPU 304 is a central processing unit for controlling the entire image forming apparatus 300 instead of the main CPU 302 when the image forming apparatus 300 is in a power saving mode. The SRAM 305 is a work memory for an operation of the sub CPU 304 and stores a control program of the sub CPU 304.

The DRAM 306 is a system work memory for an operation of the main SoC 301 and stores various programs executed by the main SoC 301 to execute an operation (a control method of an information processing apparatus) of each functional block (each unit) of the image forming apparatus 300. In addition, calculation data of the main CPU 302 is stored.

Moreover, the DRAM 306 functions also as an image memory that holds image data to which the various image processes have been applied by the image processor 303 in scanning and in printing. The ROM 307 is a boot ROM and stores a boot program of the image forming apparatus 300.

The HDD 308 is a secondary storage device and stores an application program and large capacity data of the image forming apparatus 300. The wired LAN module 312 is an interface module that transmits and receives data to/from (i.e., communicates with) an external apparatus through the wired LAN connection.

The UI 309 includes an LCD, a touch panel, a hard key, etc. so that the user can recognize and input information. The printer 310 is a printer engine that prints image data on a sheet and includes a laser scanner unit, a photoconductive drum, a sheet conveyance unit, etc. The scanner 311 reads an image and a character on a document with a CCD sensor or a CIS sensor and generates image data of the document concerned.

The wireless LAN module 700 supports the wireless standards, such as IEEE802.11a/b/g/n/ac/ax/ah. The main CPU 302 transmits and receives data to/from (i.e., communicates with) an external apparatus, such as the access point 500, through the wireless LAN module 700.

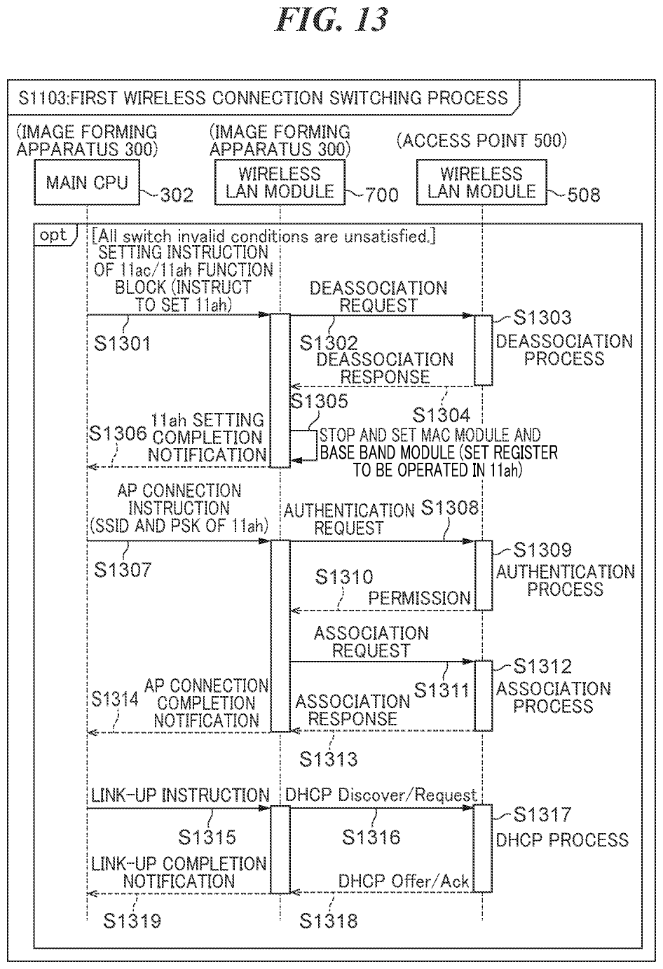

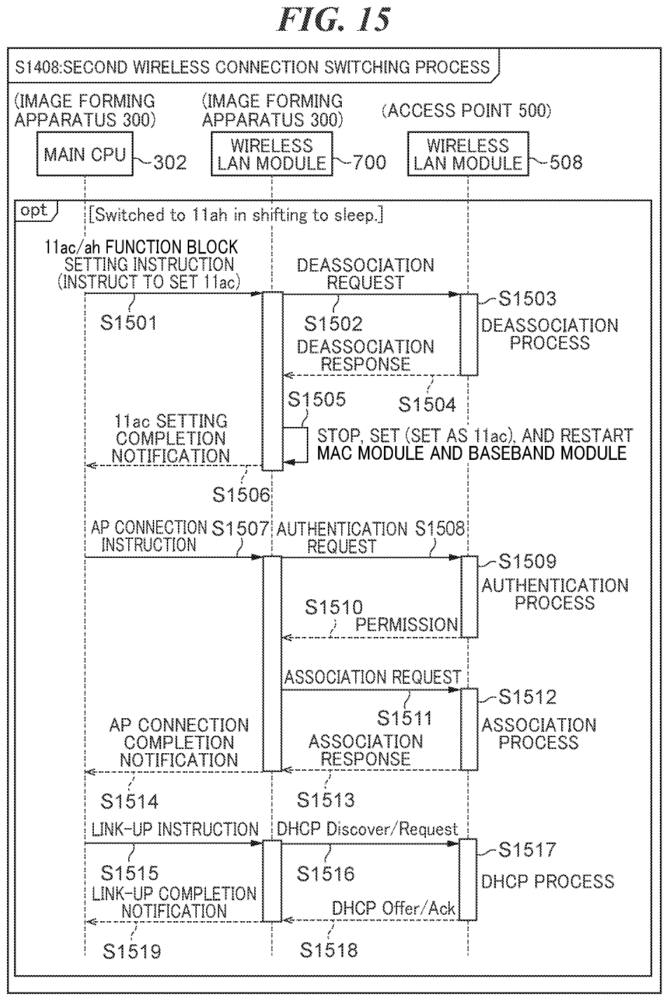

When the electric power state of the image forming apparatus 300 is the standby state, the wireless LAN module 700 is controlled to be connectable to an external apparatus through the 11ac connection. Moreover, when the electric power state of the image forming apparatus 300 is the sleep state, the wireless LAN module 700 is controlled to be connectable to an external apparatus through the 11ah connection. Each control is performed by the main CPU 302. In this way, the main CPU 302 controls to switch the 11ah connection and its stop in the wireless LAN module 700 and to switch the 11ac connection and its stop. This control is mentioned later by referring to FIG. 13 and FIG. 15.

As mentioned above, in the wireless LAN module 700, the 11ah connection and the 11ac connection are switched in accordance with the electric power state of the image forming apparatus 300. For example, when the electric power state of the image forming apparatus 300 is the standby state, the connection between the image forming apparatus 300 and the access point 500 is switched to the 11ac connection. This enables quick wireless communication.

Moreover, when the electric power state of the image forming apparatus 300 is the sleep state, the connection between the image forming apparatus 300 and the access point 500 is switched to the 11ah connection. This reduces the electric power consumption of the image forming apparatus 300. Thereby, the quick wireless communication becomes available in the standby state while reducing the electric power consumption in the sleep state in this embodiment.

Moreover, the image forming apparatus 300 is provided with the wireless LAN module 700 that supports the wireless standards, such as IEEE802.11a/b/g/n/ac/ax/ah, and the quick wireless communication becomes available by the 11ac connection while reducing the electric power consumption by the 11ac connection.

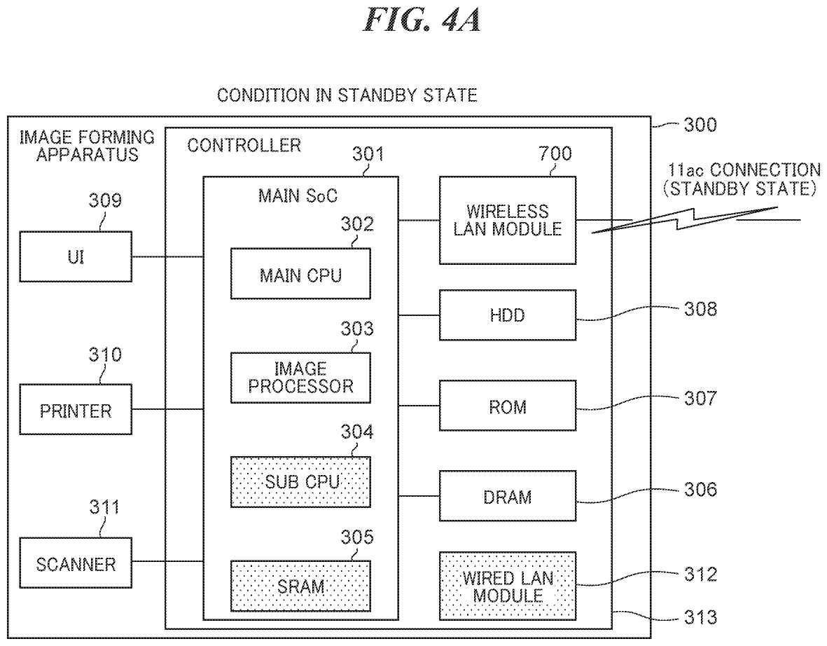

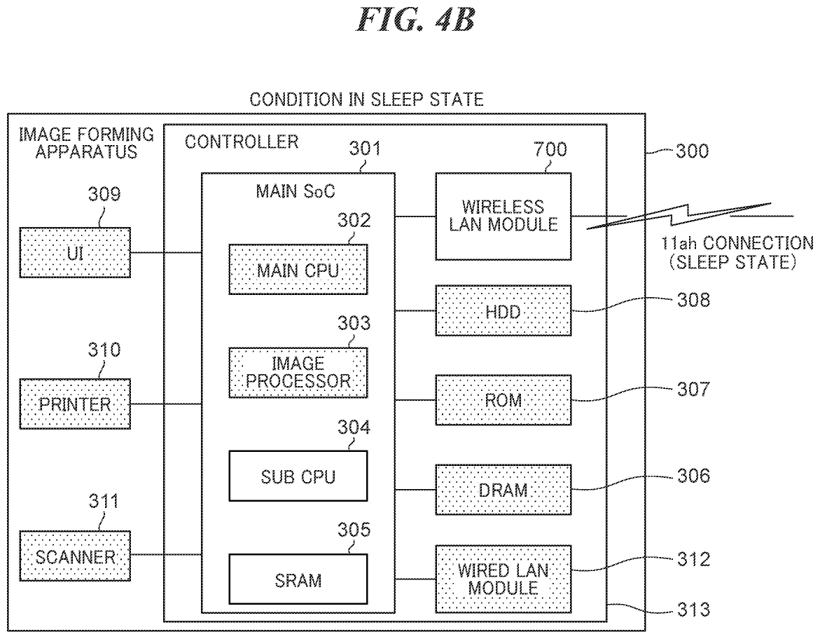

FIG. 4A and FIG. 4B are schematic views showing states of the blocks of the image forming apparatus in the respective electric power states. FIG. 4A shows a case where the electric power state of the image forming apparatus is the standby state. FIG. 4B shows a case where the electric power state of the image forming apparatus is the sleep state. Hereinafter, outlines of power saving control and returning control of the blocks will be described. Details will be mentioned later by referring to FIG. 11 and FIG. 14.

In the sleep state, the sub CPU 304 controls the entire image forming apparatus 300 instead of the main CPU 302. Accordingly, the main CPU 302 controls the sub CPU 304 to be in a clock-off state in the standby state shown in FIG. 4A that does not need the control by the sub CPU 304. The SRAM 305 is the program area and work area of the sub CPU 304. Accordingly, the main CPU 302 controls the SRAM 305 to be in the clock-off state in the standby state (i.e., the clock-off state of the sub CPU 304).

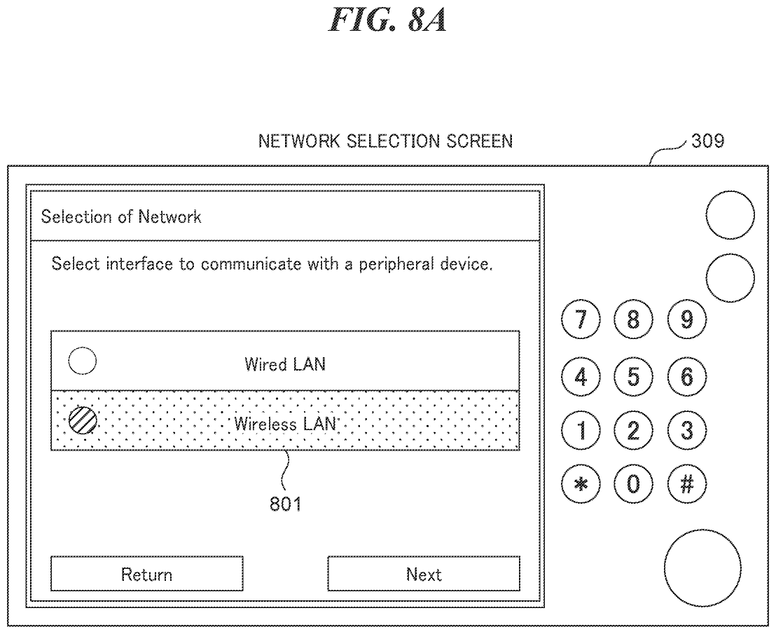

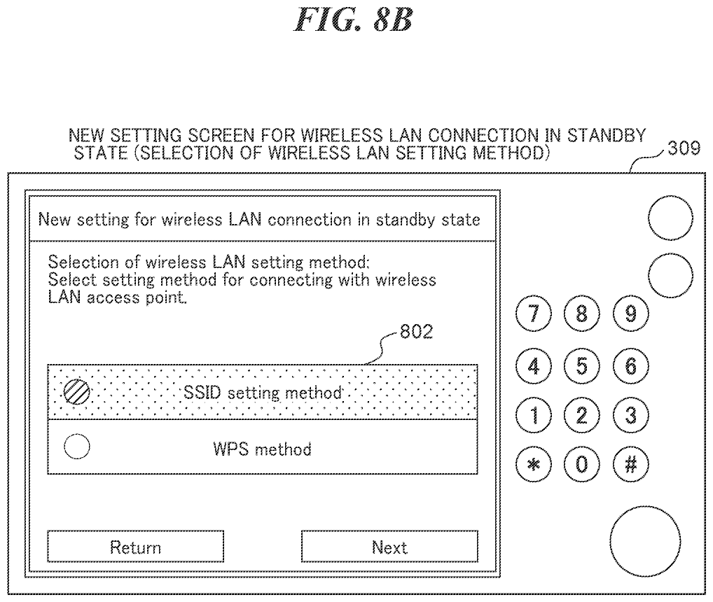

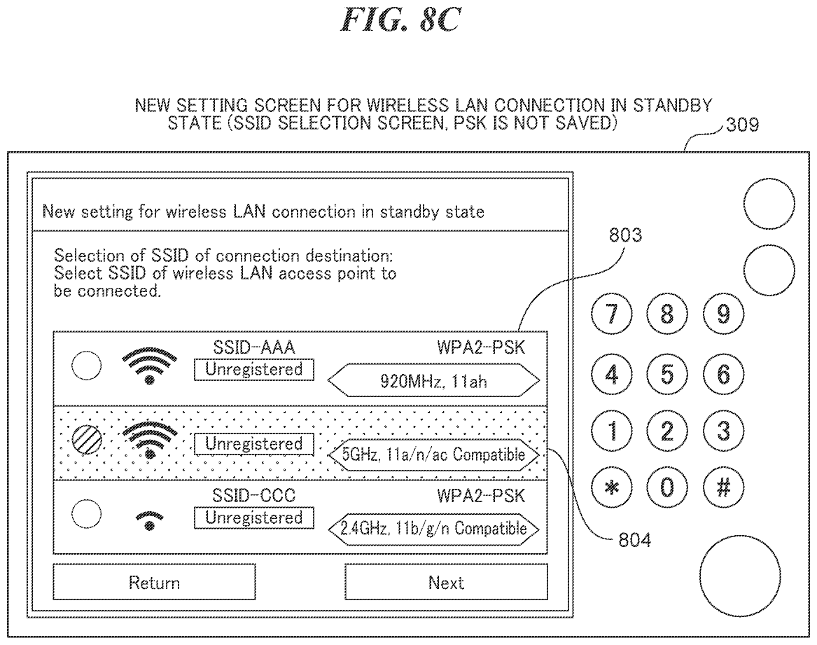

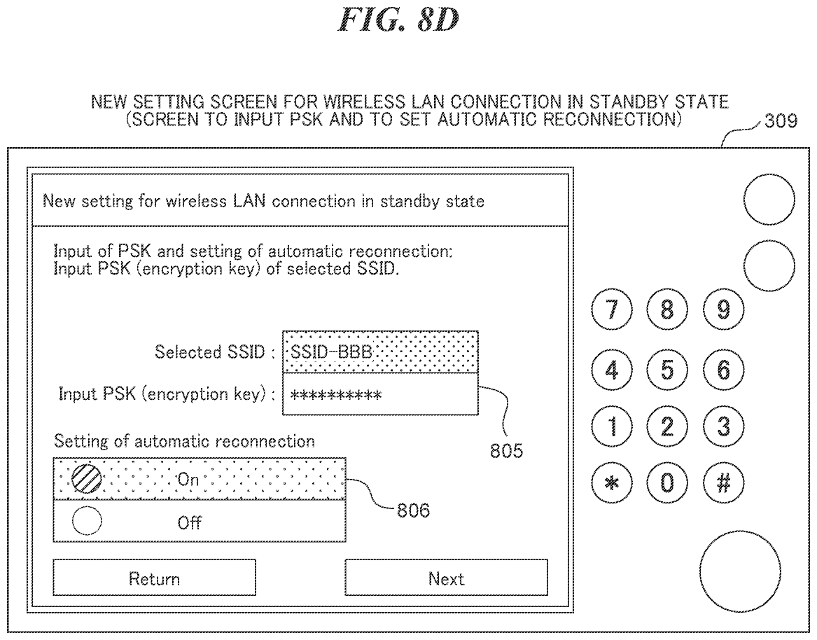

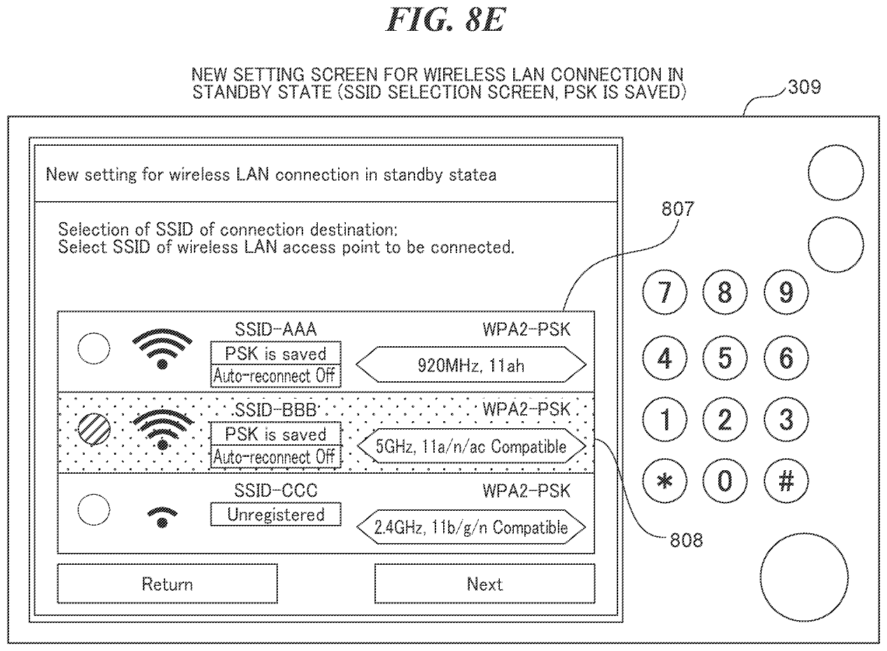

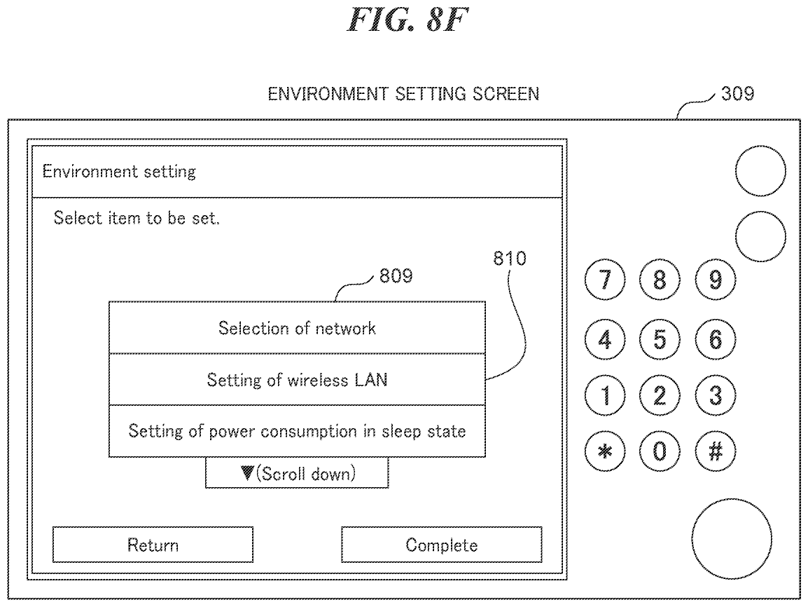

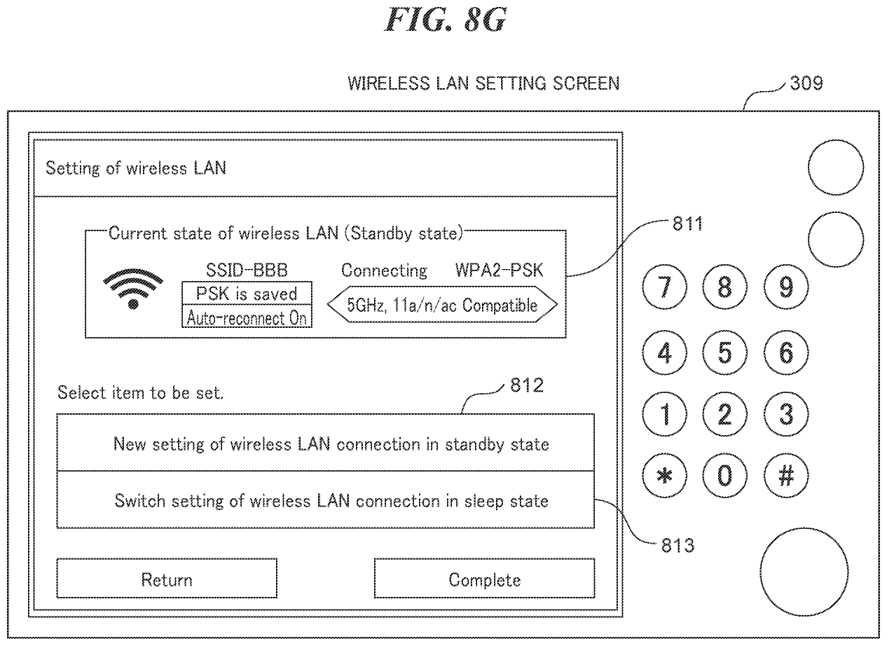

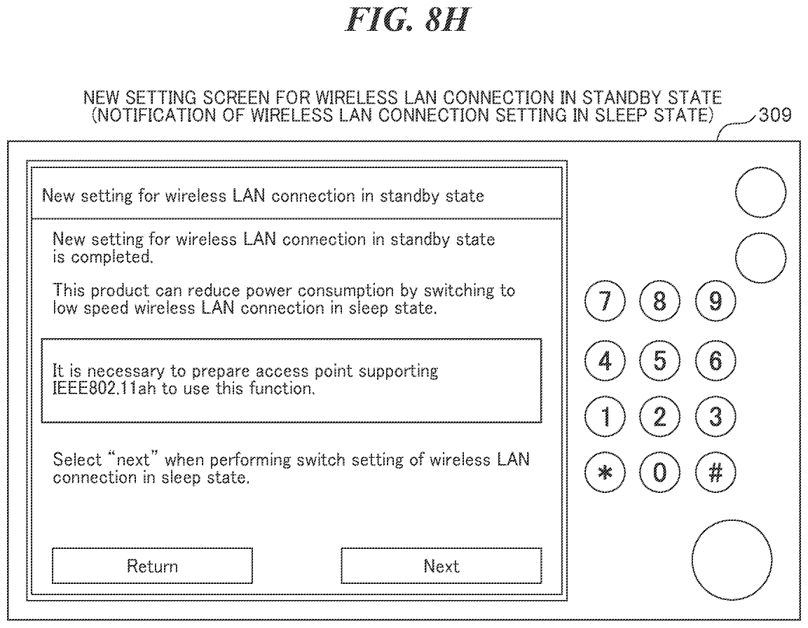

The wired LAN module 312 is always controlled to be in the power saving mode in this embodiment. This is because this embodiment presupposes that a wireless LAN is selected in a network selection screen of a user menu as mentioned later by referring to FIG. 8A.

When a wired LAN is not selected in the network selection screen, the wired LAN module 312 is not used. Accordingly, the main CPU 302 controls the wired LAN module 312 to be in a reset state or a power OFF state. The wireless LAN module 700 gives priority to the communication speed in the standby state. Accordingly, the main CPU 302 controls the wireless LAN module 700 to use the 11ac connection. This control method is mentioned later by referring to FIG. 13 and FIG. 15.

In the sleep state shown in FIG. 4B, the sub CPU 304 controls the entire image forming apparatus 300 instead of the main CPU 302 as mentioned above. Accordingly, the sub CPU 304 operates by a program developed to the SRAM 305 in the sleep state and controls the entire image forming apparatus 300. Moreover, the respective blocks are controlled to be in the following power saving states in the sleep state.

Since a heavy load calculation process is not executed, the main CPU 302 is controlled by the sub CPU 304 to be in the power saving state. Since the image process and job process are not executed, the image processor 303, printer 310, and scanner 311 are controlled by the main CPU 302 to be in the power saving state.

Since the image forming apparatus 300 is not operated by the user, the UI 309 is controlled by the main CPU 302 to be in the power saving state. Since all the program area and work area of the sub CPU 304 are reserved in the SRAM 305, the HDD 308 and ROM 307 are controlled by the main CPU 302 to be in the power saving state. Moreover, the DRAM 306 is controlled by the sub CPU 304 to be in a self-refresh state. The wireless LAN module 700 gives priority to reduction of the electric power consumption (power saving) in the sleep state.

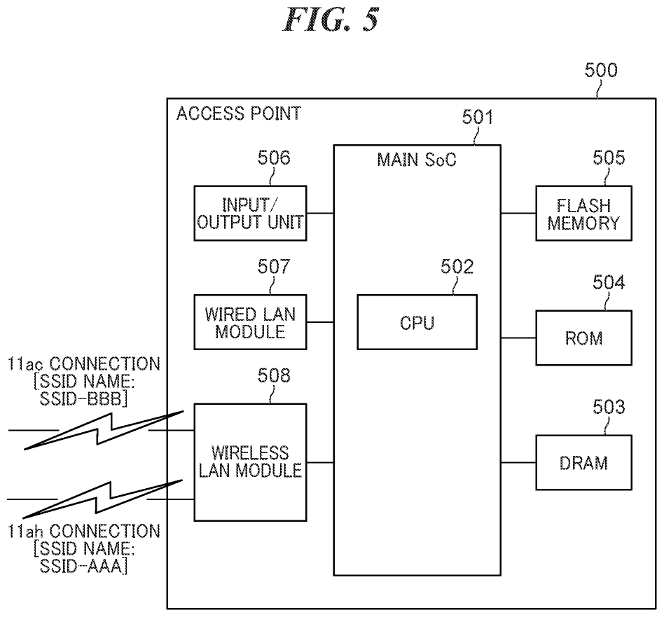

FIG. 5 is a block diagram showing the access point. As shown in FIG. 5, the access point 500 has a main SoC 501, a DRAM 503, a ROM 504, a flash memory 505, an input/output unit 506, a wired LAN module 507, and a wireless LAN module 508.

The main SoC 501 is an integrated circuit component and includes a CPU 502 in this embodiment. The CPU 502 is a central processing unit for controlling the entire access point 500. The DRAM 503 is a system work memory for an operation of the CPU 502 and stores calculation data of the CPU 502 and various programs.

The ROM 507 is a boot ROM and stores a boot program of the access point 500. The flash memory 505 is a secondary storage device and stores an operation log of the access point 500. The input/output unit 506 is a user interface and includes LEDs, hard keys, etc. so that the user can control and check the state of the access point 500.

The wired LAN module 507 is an interface module that transmits and receives data to/from an external apparatus through the wired LAN connection. The wireless LAN module 508 is similar to the wireless LAN module 700 of the image forming apparatus 300. The CPU 502 transmits and receives data to/from an external apparatus through the wireless LAN module 508.

In this embodiment, the access point 500 is connectable by either the 11ac connection or the 11ah connection. Moreover, a name of “SSID-BBB” shall be set to the 11ac connection of the access point 500 as an SSID, and a name of “SSID-AAA” shall be set to the 11ah connection of the access point 500 as an SSID. These SSIDs are used in new setting screens for the wireless LAN connection shown in FIG. 8C and FIG. 8E mentioned later.

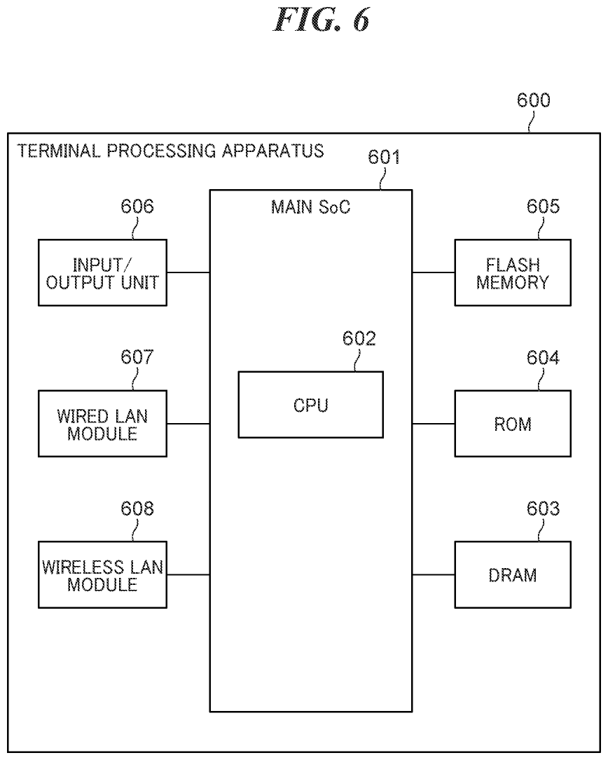

FIG. 6 is a block diagram showing the terminal processing apparatus. As shown in FIG. 6, the terminal processing apparatus 600 has a main SoC 601, a DRAM 603, a ROM 504, a flash memory 605, an input/output unit 606, a wired LAN module 607, and a wireless LAN module 608.

The main SoC 601 is an integrated circuit component and includes a CPU 602 in this embodiment. The main CPU 602 is a central processing unit for controlling the entire terminal processing apparatus 600. The DRAM 603 is a system work memory for an operation of the CPU 602 and stores calculation data of the CPU 602 and various programs.

The ROM 604 is a boot ROM and stores a boot program of the terminal processing apparatus 600. The flash memory 605 is a secondary storage device and stores an application program and large capacity data of the terminal processing apparatus 600. The input/output unit 606 is a user interface and includes a touch panel, an LCD, hard keys, etc.

The wired LAN module 607 is an interface module that transmits and receives data to/from an external apparatus through the wired LAN connection. The wireless LAN module 608 is similar to the wireless LAN module 700 of the image forming apparatus 300. The CPU 602 transmits and receives data to/from an external apparatus through the wireless LAN module 608.

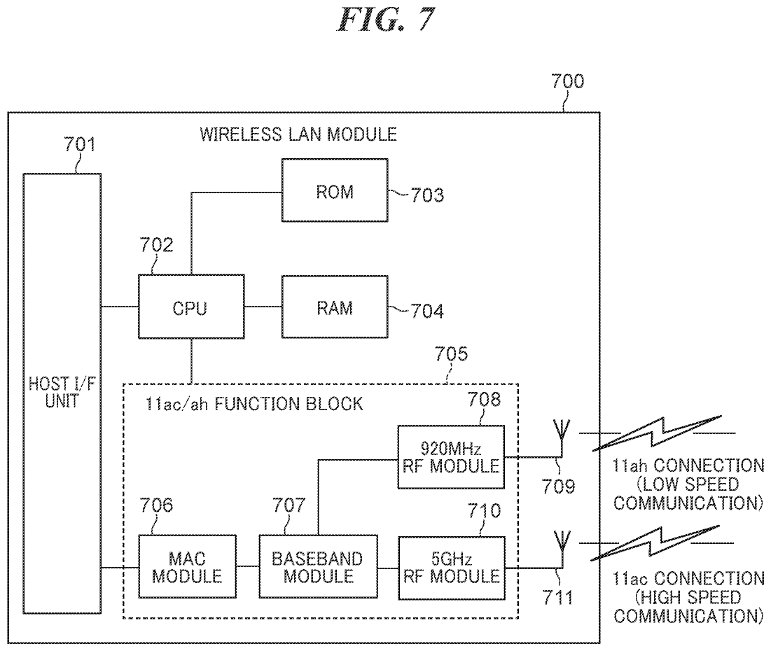

FIG. 7 is a block diagram showing the wireless LAN module 700. It should be noted that the wireless LAN module 700 is constituted so as to conform to the standards of IEEE802.11ac and 11ah. The configuration of the wireless LAN module 700 is not limited to the configuration shown in FIG. 7. For example, the wireless LAN module 700 may be constituted so as to conform to other standards, such as IEEE802.11a/b/g/n/ax.

As shown in FIG. 7, the wireless LAN module 700 has a host I/F unit 701, a CPU 702, a ROM 703, a RAM 704, and a 11ac/ah function block 705. The host I/F unit 701 is an interface with a host system to which the wireless LAN module 700 is connected. The host I/F unit 701 is connected with the host system through a protocol, such as general USB, SDIO, or UART.

In this embodiment, the host I/F unit 701 is constituted so as to be connectable to the main SoC 301. The CPU 702 is a central processing unit for controlling the entire wireless LAN module 700. The CPU 702 communicates with the host system through the host I/F unit 701. Then, the CPU 702 controls the blocks of the wireless LAN module 700 in response to a request from the host system. The ROM 703 is a nonvolatile memory that stores program data of the CPU 702. The RAM 704 is a work memory for an operation of the CPU 702 and stores a control program of the CPU 702.

The 11ac/ah function block 705 includes a MAC module 706, a baseband module 707, a 920-MHz RF module 708, and a 5-GHz RF module 710 in this embodiment. These blocks are controlled by the CPU 702. The MAC module 706 is a MAC (Media Access Control) layer that conforms to the specification defined by the standards of IEEE802.11ac and 11ah. The MAC module 706 executes an IP packet process that gives and deletes a MAC address in connection with a data link layer. Moreover, CSMA/CA is designated in the MAC module 706 as a protocol for avoiding an access collision on the network. Functions of RAW (Restricted Access Window) and TWT (Target Wake Time) are added to the MAC module 706 for power saving in the 11ah connection.

The CPU 702 can switch the function of the MAC module 706 to the 11ac connection or the 11ah connection in response to a request from the host system. The baseband module 707 conforms to the specification defined by the standards of IEEE802.11ac and 11ah. The baseband module 707 has a function that modulates or demodulates between a MAC-processed IP packet signal and a baseband signal. In the baseband module 707, OFDM (Orthogonal Frequency Division Multiplexing) is designated as a data modulation method. Moreover, the baseband module 707 is designed so that the clock frequency in the 11ah connection is equal to 1/10 of the clock frequency in the 11ac connection for power saving. The CPU 702 can switch the function of the baseband module 707 to the 11ac connection or the 11ah connection in response to a request from the host system.

At a time of reception, the 920-MHz RF module 708 restores a baseband signal by removing a wireless carrier wave frequency from a wireless signal received through an antenna 709 and sends out it to the baseband module 707. Moreover, at a time of transmission, the 920-MHz RF module 708 puts the baseband signal from the baseband module 707 on the wireless carrier wave frequency and sends out the wireless signal through the antenna 709. The 920-MHz RF module 708 supports generation and removal of the carrier wave in a 920 MHz band used by the 11ah connection. The CPU 702 can start (turn ON) and stop (turn OFF) the function of the 920-MHz RF module 708 in response to a request from the host system.

At a time of reception, the 5-GHz RF module 710 restores a baseband signal by removing a wireless carrier wave frequency from a wireless signal received through an antenna 711 and sends out it to the baseband module 707. Moreover, at a time of transmission, the 5-GHz RF module puts the baseband signal from the baseband module 707 on the wireless carrier wave frequency and sends out the wireless signal through the antenna 711. The 5-GHz RF module 710 supports generation and removal of the carrier wave in a 5 GHz band used by the 11ac connection. The CPU 702 can start (turn ON) and stop (turn OFF) the function of the 5-GHz RF module 710 in response to a request from the host system.

In this way, the wireless LAN module 700 of the image forming apparatus 300 has a function as a reception unit that receives data (receiving process) and a function as a communication unit that wirelessly communicates (communication process). It should be noted that the image forming apparatus 300 may be constituted so as to have the block functioning as the reception unit and the block functioning as the communication unit separately. As mentioned above, the wireless LAN module 700 may be constituted so as to conform to other standards, such as IEEE802.11a/b/g/n/ax. In this case, the MAC module 706 and the baseband module 707 should be designed and controlled so as to support an additional standard. Moreover, when the wireless LAN module 700 conforms to the standards of IEEE802.11n and 11ax, an RF module and an antenna that support 2.4 GHz communication should be connected to the baseband module 707.

FIG. 8A through FIG. 8H are views showing screen examples concerning the wireless LAN connection displayed on the UI 309 of the image forming apparatus 300. FIG. 8A shows an example of a network selection screen. FIG. 8B through FIG. 8E and FIG. 8H show examples of new setting screens for the wireless LAN connection in the standby state. FIG. 8F shows an example of an environment setting screen. FIG. 8G shows an example of a wireless LAN setting screen. The various setting screens shown in FIG. 8A through FIG. 8H can be displayed when a user operates the UI 309 to change a screen. In general, the setting screens can be displayed from the user menu in which the environment setting and network setting are available. Hereinafter, display contents of the various setting screen will be described.

The environment setting screen shown in FIG. 8F is used to select items for the network connection setting and the electric power control setting. When “selection of network” 809 is selected in the environment setting screen, the screen is changed to the network selection screen shown in FIG. 8A. Moreover, when “setting of wireless LAN” 810 is selected in the environment setting screen, the screen is changed to the wireless LAN setting screen shown in FIG. 8G.

The network selection screen shown in FIG. 8A is used to select an interface that connects the image forming apparatus 300 to an external network. When the wireless LAN 801 is selected in this screen, the connection using the wireless LAN module 700 becomes available.

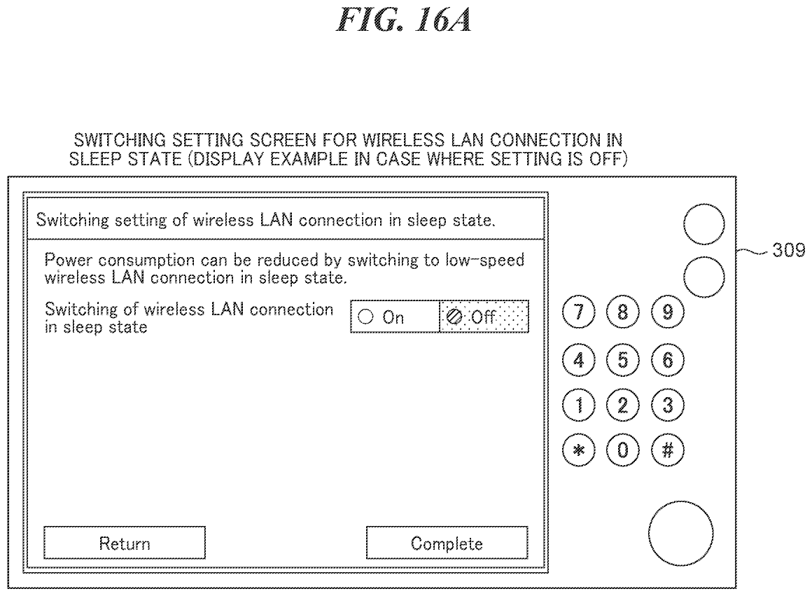

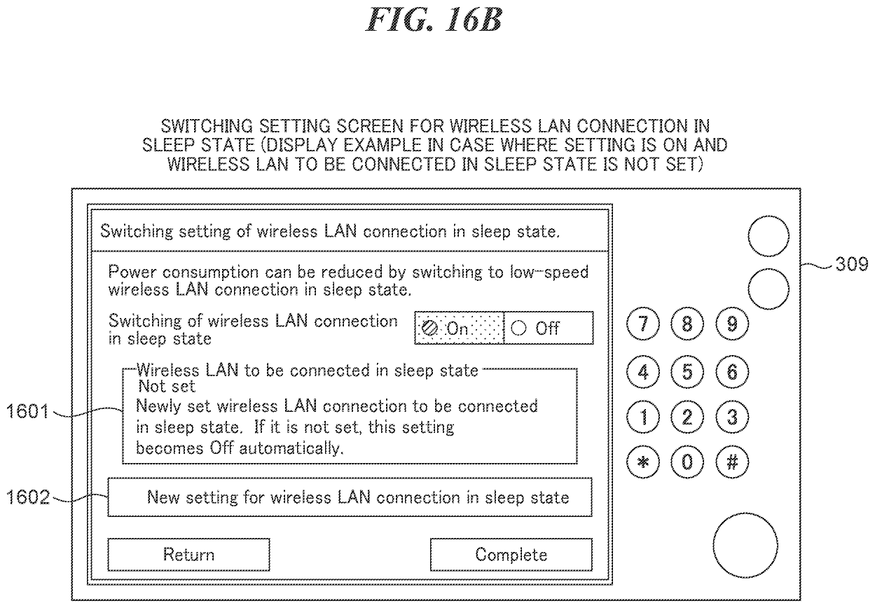

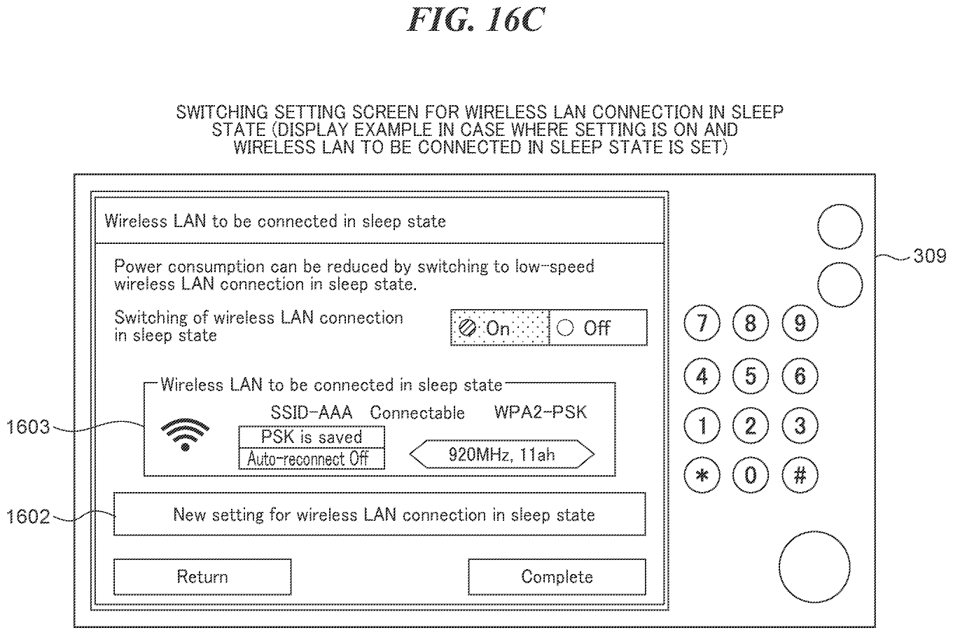

In the wireless LAN setting screen shown in FIG. 8G, information 811 that shows the state of the wireless LAN connection of the image forming apparatus 300 is displayed. Moreover, when “new setting of wireless LAN connection in standby state” 812 is selected in the wireless LAN setting screen, the screen is changed to a new setting screen for a wireless LAN setting method shown in FIG. 8B. Moreover, when “switch setting of wireless LAN connection in sleep state” 813 is selected in the wireless LAN setting screen, the screen is changed to the switching setting screens for the wireless LAN connection in the sleep state shown in FIG. 16A, FIG. 16B, and FIG. 16C mentioned later.

FIG. 8B is a view showing a selection screen for a wireless LAN setting method. In this screen, either an SSID setting method or a WPS (Wi-Fi Protected Setup) method can be selected. Both the WPS method and the SSID setting method are well-known. FIG. 8B shows a state where the SSID setting method 802 has been selected. FIG. 8C is a view showing an SSID selection screen that displays a list of SSIDs of access points around the image forming apparatus 300. FIG. 8C shows a state where connection modes that the SSIDs support are displayed. For example, a connection mode 803 displays that SSID-AAA is connectable through the 11ah connection at 920 MHz. Moreover, a connection mode 804 displays that SSID-BBB is connectable by the IEEE802.11a/n/ac connections at 5 GHz. It should be noted that FIG. 8C shows that an encryption key called a PSK (Pre Shared Key) is in an unsaved state in every SSID.

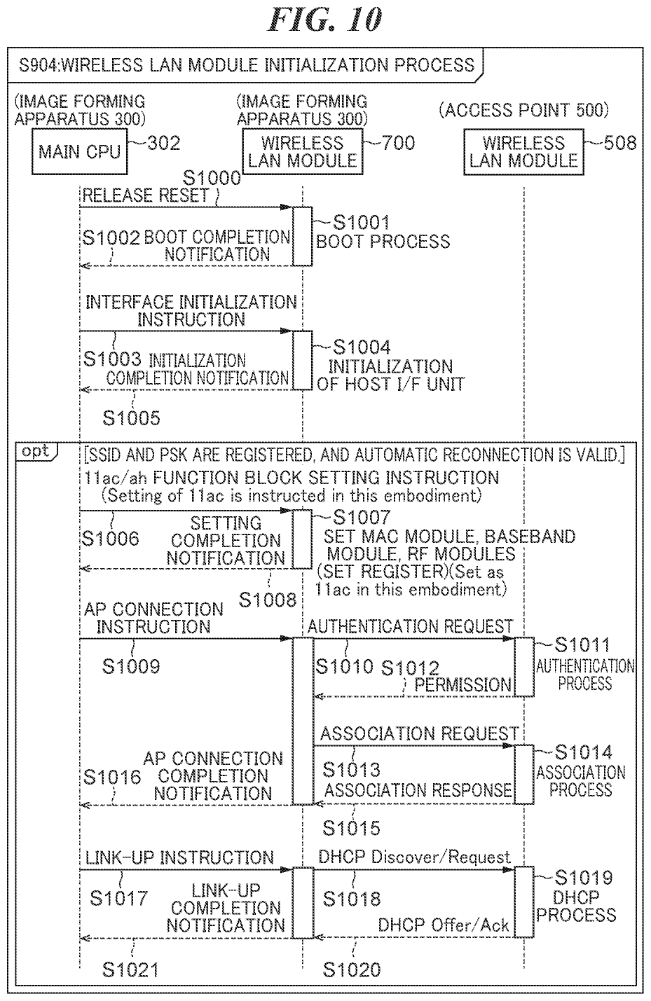

FIG. 8D is a view showing a screen displayed when the SSID-AAA is selected in the screen shown in FIG. 8C. In the screen shown in FIG. 8D, a PSK may be input and automatic reconnection may be set. When a correct PSK is input into a PSK input column 805, the SSID concerned becomes in a PSK saved state. After that, the connection to the SSID concerned becomes available without inputting a PSK. Moreover, when the automatic reconnection 806 is set to ON, the reconnection process will be performed automatically in the initialization process of the wireless LAN module 700. The initialization process of the wireless LAN module 700 is mentioned later by referring to FIG. 10.

FIG. 8H is a view showing a screen displayed when the connection to the above-mentioned SSID becomes available in the screen shown in FIG. 8D. In the screen shown in FIG. 8H, a notification showing that the electric power consumption can be reduced by switching the wireless LAN connection of the image forming apparatus 300 in the sleep state (i.e., a notification that prompts a user to switch the setting of the wireless LAN connection in the sleep state) is displayed. This notifies a user that the electric power consumption can be reduced using such a switch function. A setting item to turn off the display in FIG. 8 may be provided in another setting screen.

In this embodiment, it is determined whether the user is notified or not according to a user's instruction as mentioned above. This prevents deterioration of operation feeling because an unnecessary notification is not repeatedly sent to a user who understands that the electric power consumption can be reduced by using the switch function mentioned above.

FIG. 8E is a view showing an SSID selection screen and shows a displaying state of an SSID in which a PSK is saved. In the screen shown in FIG. 8E, a message “PSK is saved” is displayed for the SSID-AAA (807) connectable through the 11ah connection and for the SSID-BBB (808) connectable through the 11ac connection. Moreover, in the screen shown in FIG. 8E, a message “Automatic reconnection is ON” is also displayed for the SSID-AAA (807) and SSID-BBB (808). As mentioned above, the image forming apparatus 300 switches the wireless LAN connection state in accordance with the electric power state. This switching needs to save SSIDs and PSKs connectable through the 11ah connection and 11ac connection (see FIG. 8 E) beforehand.

FIG. 9 is a view showing a boot sequence of the image forming apparatus. The boot sequence S900 shown in FIG. 9 is started by the trigger that is the press of the power switch in the step S201 (see FIG. 2) as mentioned above. In a step S901, the main CPU 302 develops the boot program stored in the ROM 307 and the application program stored in the HDD 308 to the DRAM306 as load of firmware.

In a step S902, the main CPU 302 controls to turn ON the power of the UI 309 and controls to display a state where the image forming apparatus 300 is starting to a user. In a step S903, the main CPU 302 controls to turn ON the powers of the printer 310 and scanner 311. In a step S904, the main CPU 302 executes a wireless LAN module initialization process to the wireless LAN module 700 (similar also to the wireless LAN module 508 of the access point 500). The process in the step S904 is executed only when the wireless LAN is selected in the screen shown in FIG. 8A. The process in the step S904 is mentioned later by referring to FIG. 10.

In a step S905, the main CPU 302 executes a shifting-to-standby completion process. Moreover, in the step S905, the main CPU 302 switches the display of the UI 309 from a starting screen to a home screen or a main menu screen, for example. Thereby, a user is notified that the booting is completed.

FIG. 10 is a view showing a sequence of the wireless LAN module initialization process in the step S904. In a step S1000, the main CPU 302 releases reset of the wireless LAN module 700. In a step S1001, the CPU 702 of the wireless LAN module 700 develops the program stored in the ROM 703 to the RAM 704 and executes a boot process.

In a step S1002, the wireless LAN module 700 sends out (transmits) a boot completion notification to the main CPU 302. Thereby, the main CPU 302 can determine boot completion of the wireless LAN module 700. It should be noted that the main CPU 302 may wait during a definite period without sending the boot completion notification by the wireless LAN module 700. In this case, when the definite period elapses, the main CPU 302 estimates that the boot process of the wireless LAN module 700 is completed.

The initialization sequence performed in steps S1003 through S1005 follows a general interface protocol. The host I/F unit 701 employs a protocol, such as USB, SDIO, or UART, as mentioned above. Although these initialization sequences are well-known, an example of them is described hereinafter. In a step S1003, the main CPU 302 sends out an interface initialization instruction to the wireless LAN module 700. The interface initialization instruction is release of the software reset of the host I/F unit 701, setting of a data rate between the main SoC 301 and host I/F unit 701, etc., for example. In a step S1004, the wireless LAN module 700 executes initialization of the host I/F unit 701 on the basis of the interface initialization instruction. In a step S1005, the wireless LAN module 700 sends out an initialization completion notification to the main CPU 302.

In a step S1006, the main CPU 302 sends out a setup instruction of the 11ac/ah function block 705 to the wireless LAN module 700. Steps S1006 through S1021 are executed only when the SSID and PSK of the 11ac (or 11ah) connection of the access point 500 are registered in the input screen shown in FIG. 8D and the automatic reconnection is set to ON. Although the case where the setup instruction of a 11ac function block is sent out in the step S1006 is shown as an example, the setup instruction of a 11ah function block may be sent out.

When SSIDs and PSKs of both of the 11ac connection and 11ah connection are registered and the automatic reconnection is set to ON, priority is given to a communication speed in the step S1006. Accordingly, the main CPU 302 controls the wireless LAN module to use the 11ac connection. In a step S1007, the CPU 702 of the wireless LAN module 700 sets up a register so that the blocks of the 11ac/ah function block 705 can operate by the 11ac connection.

In a step S1008, the wireless LAN module 700 sends out a setting completion notification to the main CPU 302. In a step S1009, the main CPU 302 sends out an AP connection instruction (an instruction connecting to the access point 500) to the wireless LAN module 700. Moreover, in the step S1009, the main CPU 302 notifies the wireless LAN module 700 of the SSID and PSK.

In steps S1010 through S1015, the CPU 702 of the wireless LAN module 700 controls the 11ac/ah function block 705 to execute an authentication process and association process based on the IEEE802.11 standard with the access point 500. The steps S1010 through S1012 correspond to the authentication process, and the steps S1013 through S1015 correspond to the association process. The authentication process and association process in the steps S1010 through S1015 are based on the IEEE802.11 standard and are well-known.

In a step S1016, after completing the association process, the wireless LAN module 700 sends out an AP (access point) connection completion notification to the main CPU 302. In a step S1017, the main CPU 302 sends out a link-up instruction (DHCP Discover, the instruction to link-up to the network) to the wireless LAN module 700. In steps S1018 through S1020, the CPU 702 of the wireless LAN module 700 controls the 11ac/ah function block 705 to obtain an IP address from a DHCP server (not shown) through the access point 500. In a step S1021, the wireless LAN module 700 sends out the IP address together with the link-up completion notification to the main CPU 302.

The image forming apparatus 300 is connected to the IP network through the wireless LAN by passing through such steps. Then, since the image forming apparatus 300 is connected to the network through the 11ac connection on boot by performing the sequences shown in FIG. 9 and FIG. 10, high-speed communication is available as compared with the 11ah connection.

FIG. 11 is a view showing a shifting-to-sleep sequence of the image forming apparatus. The shifting-to-sleep sequence S1100 is started by the trigger that is the press of the power saving key of the image forming apparatus 300 in the step S202 (see FIG. 2) as mentioned above. It should be noted that the shifting-to-sleep sequence may be started when the CPU 302 detects a timer interrupt signal besides the press of the power saving key. In this embodiment, the shifting-to-sleep sequence shall begin by the press of the power saving key.

In a step S1101, the main CPU 302 controls to turn OFF the powers of the printer 310 and scanner 311. In a step S1102, the main CPU 302 executes a clock gating process as a power saving process of the image processor 303.

In a step S1103, the main CPU 302 executes a first wireless connection switching process to the wireless LAN module 700. The process in the step S1103 is executed only when the wireless connection between the image forming apparatus 300 and the access point 500 through the wireless LAN module 700 is completed. In the meantime, when the wireless connection with the access point 500 is not completed, the main CPU 302 executes a reset assert to the wireless LAN module 700 in a step S1104. The process in the step S1103 is mentioned later by referring to FIG. 13.

In a step S1105, the main CPU 302 executes the power saving process by controlling to turn off a back light of the UI 309, etc. In a step S1106, the main CPU 302 develops a program of the sub CPU 304 to the SRAM 305 and executes the internal reset release to the sub CPU 304 to boot the sub CPU 304.

In a step S1107, the main CPU 302 executes a power gating process as the power saving process for the ROM 307 and HDD 308. In a step S1108, the sub CPU 304 executes the clock gating process to the main CPU 302. Thereby, the main CPU 302 becomes in a stopped state. In a step S1109, the sub CPU 304 brings the DRAM 306 to a self-refresh state.

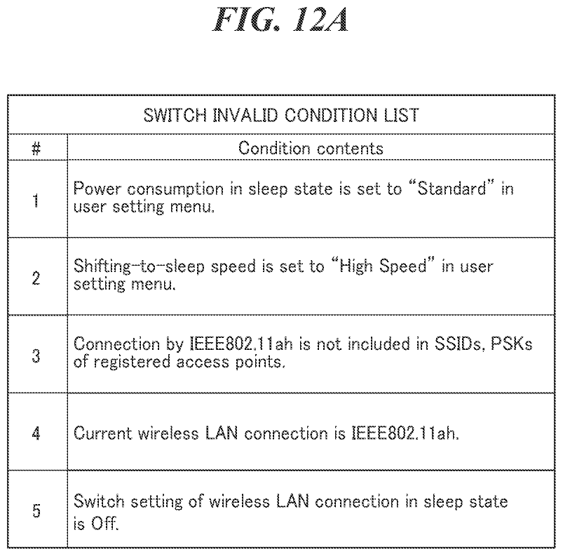

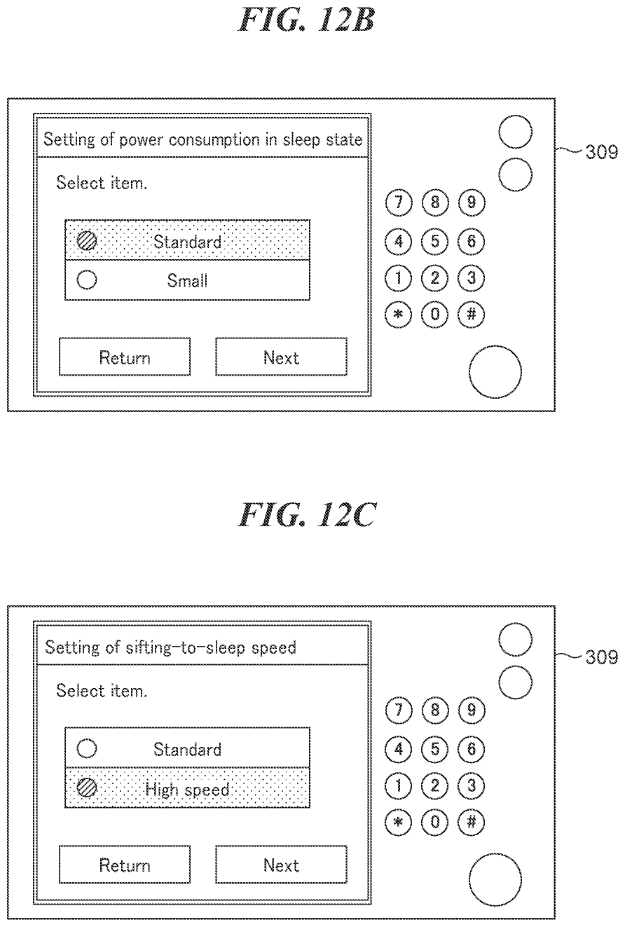

FIG. 12A through FIG. 12C are views showing screen examples displayed concerning the sleep state and the standby state. FIG. 12A shows a list of “switch invalid conditions” that invalidate the switching of the wireless connection by the first wireless connection switching process in the step S1103 mentioned above. FIG. 12B shows an example of a setting screen of power consumption in the sleep state. FIG. 12C shows an example of a setting screen of a speed in shifting to the sleep state.

As shown in FIG. 12A, the list includes five switch invalid conditions, for example. A first switch invalid condition shows a case where the sleep electric power setting, which is set to “standard” or “small”, is set to “standard” in a user setting menu. An example of the screen of the user setting menu under the first switch invalid condition is shown in FIG. 12B. In the description, the selection item names “standard” and “small” are examples. The “standard” may be expressed as “large”. The first switch invalid condition is a condition for controlling not to switch to the 11ah connection when it is not necessary to reduce the sleep electric power.

A second switch invalid condition shows a case where the speed setting in shifting to the sleep state (a shifting-to-sleep speed), which is set to “standard” or “high speed”, is set to “high speed” in the user setting menu. An example of the screen of the user setting menu under the second switch invalid condition is shown in FIG. 12C. In the description, the selection item names “standard” and “high speed” are examples. The “standard” may be expressed as “low speed” or “slow”. The second switch invalid condition is a condition for controlling not to switch to the 11ah connection when it is wanted to heighten the shifting-to-sleep speed (it is wanted to shorten a shifting period).

A third switch invalid condition shows a case where the SSIDs and PSKs of the access points registered beforehand do not include the 11ah connection. A fourth switch invalid condition shows a case where the wireless LAN has already connected through the 11ah connection. A fifth switch invalid condition shows a case where the switch setting of the wireless LAN connection in the sleep state is set to OFF. The fifth switch invalid condition is a condition for controlling not to switch to the 11ah connection when the switch setting is set to OFF as shown in a screen in FIG. 16A mentioned later.

FIG. 13 is a view showing a sequence of the first wireless connection switching process S1103. The first wireless connection switching process in steps S1301 through S1319 shown in FIG. 13 is executed only when all the items of the switch invalid conditions shown in FIG. 12A are unsatisfied. Accordingly, when at least one switch invalid condition is satisfied, the process in the steps S1301 through S1319 is not executed. In this way, in this embodiment, it is determined whether the process in the steps S1301 through S1319 is executed on the basis of the switch invalid conditions (predetermined conditions about switching) that are set up by the user. Thereby, a user's intention can be reflected to the execution of the steps S1301 through S1319.

As shown in FIG. 13, in a step S1301, the main CPU 302 sends out a setup instruction of the 11ac/ah function block 705 to the wireless LAN module 700. In the step S1301, the setup instruction of the 11ah connection is sent out, for example, in order to reduce the electric power consumption. In steps S1302 through S1304, the wireless LAN module 700 performs a deassociation process (a disconnection process) for disconnecting from the access point 500. The process in the steps S1302 through S1304 is based on the IEEE802.11 standard and is well-known.

When the deassociation process is completed, the CPU 702 of the wireless LAN module 700 sets up the register in a step S1305 so that the blocks of the 11ac/ah function block 705 can operate by the 11ah connection. The setup period of the register setting here can be shortened by using only difference set values between the 11ac connection and 11ah connection.

In a step S1306, the wireless LAN module 700 sends out a 11ah setting completion notification to the main CPU 302. In a step S1307, the main CPU 302 sends out the AP connection instruction (an instruction connecting to the access point 500) to the wireless LAN module 700. In this step S1307, the main CPU 302 notifies the wireless LAN module 700 of the SSID and PSK of the registered 11ah connection, for example.

In steps S1308 through S1313, the CPU 702 of the wireless LAN module 700 controls the 11ac/ah function block 705 and executes an authentication process and an association process based on the IEEE802.11 standard with the access point 500. The steps S1308 through S1310 correspond to the authentication process, and the steps S1311 through S1313 correspond to the association process. The authentication process and association process in the steps S1308 through S1313 are based on the IEEE802.11 standard and are well-known.

In a step S1314, after completing the association process, the wireless LAN module 700 sends out the AP (access point) connection completion notification to the main CPU 302. In a step S1315, the main CPU 302 sends out the link-up instruction (DHCP Discover, the instruction to link-up to the network) to the wireless LAN module 700.

In steps S1316 through S1318, the CPU 702 of the wireless LAN module 700 controls the 11ac/ah function block 705 to obtain an IP address from a DHCP server (not shown) through the access point 500. In a step S1319, the wireless LAN module 700 sends out the IP address together with the link-up completion notification to the main CPU 302.

Since the network connection is achieved by the 11ah connection by performing the shifting-to-sleep sequence (including the first wireless connection switching process in FIG. 13) shown in FIG. 11, the wireless LAN module 700 can be brought into a low power state as compared with the 11ac connection.

It should be noted that the message communications in the steps S1306, S1307, S1314, and S1315 may be gathered to the two steps S1301 and S1319 in order to shorten a switching period. That is, the CPU 702 of the wireless LAN module 700 may be constituted so as to perform required processes in succession until a step S1319 after the reception in the step S1301. In this case, the main CPU 302 preferably sends out the information, such as the SSID and PSK, to the wireless LAN module 700 in the step S1301.

FIG. 14 is a view showing the returning-to-standby sequence S1400 of the image forming apparatus. The returning-to-standby sequence S1400 is started by the trigger that is the print job execution operation to the terminal processing apparatus 600 in the step S208 (see FIG. 2).

In steps S1401 through S1404, when a job is input into the image forming apparatus 300 from the terminal processing apparatus 600 through the IP network, the wireless LAN module 700 that receives job data transmits an interrupt signal to the sub CPU 304. This starts the returning-to-standby sequence. It should be noted that the returning-to-standby sequence may be started when the sub CPU 304 detects timer interruption, power saving key interruption, human sensor interruption, etc. besides the job reception interruption. In this embodiment, the returning-to-standby sequence shall begin by the job reception.

In a step S1405, the sub CPU 304 that received the interrupt signal from the wireless LAN module 700 releases the self-refresh of the DRAM 306. In a step S1406, the sub CPU 304 returns the main CPU 302 by releasing the clock gating of the main CPU 302. At this time, the sub CPU 304 notifies the main CPU 302 that the return is due to the job reception through the wireless LAN. In a step S1407, the main CPU 302 releases the power gating process for the ROM 307 and HDD 308.

In a step S1408, the main CPU 302 executes a second wireless connection switching process to the wireless LAN module 700. The process in the step S1408 is mentioned later by referring to FIG. 15.

In steps S1409 through S1411, the main CPU 302 requests retransfer of the job data from the terminal processing apparatus 600 through the wireless LAN module 700 and access point 500.

In steps S1412 through S1414, the terminal processing apparatus 600 that received the retransfer request transmits the print job to the image forming apparatus 300 again. The job data that is received by the image forming apparatus 300 is stored in the DRAM 306 or the HDD 308.

In a step S1415, the main CPU 302 controls to turn ON the power of the UI 309. Thereby, the back light of the UI 309 lights and the UI 309 returns to an operatable electric power state, i.e., a normal state. In a step S1416, the main CPU 302 executes a process for releasing the clock gating of the image processor 303. Thereby, the image processor 303 returns to the operatable electric power state, i.e., the normal state.

In a step S1417, the main CPU 302 controls to turn OFF the powers of the printer 310 and scanner 311. Thereby, the printer 310 and scanner 311 return to the operatable electric power state, i.e., the normal state. In a step S1418, the main CPU 302 stops the operation of the sub CPU 304. In a step S1419, the main CPU 302 executes a print process using the job data received in the step S1414.

FIG. 15 is a view showing a sequence of the second wireless connection switching process S1408. Steps S1501 through S1519 shown in FIG. 15 are steps for executing the second wireless connection switching process and are executed only when the connection is switched to the 11ah connection in the shifting-to-sleep sequence. That is, the steps S1501 through S1519 are executed only when the steps S1301 through S1319 are executed in shifting to the sleep state. Thereby, the connection state of the wireless LAN that was switched to the 11ah connection in the shifting-to-sleep sequence in order to reduce the electric power consumption is returned to the 11ac connection in returning to the standby state and a high communication speed is achieved.

In a step S1501, the main CPU 302 sends out a setup instruction of the 11ac/ah function block 705 to the wireless LAN module 700. In the step S1501, the setup instruction of the 11ac connection is sent out, for example, in order to achieve the high communication speed. In steps S1502 through S1504, the wireless LAN module 700 performs the deassociation process (the disconnection process) for disconnecting from the access point 500. The process in the steps S1502 through S1504 is based on the IEEE802.11 standard and is well-known.

When the deassociation process is completed, the CPU 702 of the wireless LAN module 700 sets up the register in a step S1505 so that the blocks of the 11ac/ac function block 705 can operate by the 11ac connection. The setup period of the register setting here can be shortened by using only difference set values between the 11ac connection and 11ah connection.

In a step S1506, the wireless LAN module 700 sends out a 11ac setting completion notification to the main CPU 302. In a step S1507, the main CPU 302 sends out the AP connection instruction (an instruction connecting to the access point 500) to the wireless LAN module 700. In this step S1507, the main CPU 302 notifies the wireless LAN module 700 of the SSID and PSK of the registered 11ac connection, for example.

In steps S1508 through S1513, the CPU 702 of the wireless LAN module 700 controls the 11ac/ah function block 705 and executes the authentication process and the association process based on the IEEE802.11 standard with the access point 500. The steps S1508 through S1510 correspond to the authentication process, and the steps S1511 through S1513 correspond to the association process. The authentication process and association process in the steps S1508 through S1513 are based on the IEEE802.11 standard and are well-known.

In a step S1514, after completing the association process, the wireless LAN module 700 sends out the AP (access point) connection completion notification to the main CPU 302. In a step S1515, the main CPU 302 sends out the link-up instruction (DHCP Discover, the instruction to link-up to the network) to the wireless LAN module 700. In steps S1516 through S1518, the CPU 702 of the wireless LAN module 700 controls the 11ac/ah function block 705 to obtain an IP address from a DHCP server (not shown) through the access point 500. In a step S1519, the wireless LAN module 700 sends out the IP address together with the link-up completion notification to the main CPU 302.

Since the network connection is achieved by the 11ac connection when returning to the standby state from the sleep state by performing the returning-to-standby sequence (including the second wireless connection switching process in FIG. 15) shown in FIG. 14, the high speed communication becomes available as compared with the 11ah connection.

It should be noted that the message communications in the steps S1506, S1507, S1514, and S1515 may be gathered to the two steps S1501 and S1519 in order to shorten a switching period. That is, the CPU 702 of the wireless LAN module 700 may be constituted so as to perform required processes in succession until the step S1519 after the reception in the step S1501. In this case, the main CPU 302 preferably sends out the information, such as the SSID and PSK, to the wireless LAN module 700 in the step S1501.

FIG. 16A through FIG. 16C are views showing examples of switching setting screens for the wireless LAN connection in the sleep state. In each of the switching setting screens, a message showing that the electric power consumption can be reduced by switching the wireless LAN connection of the image forming apparatus 300 in the sleep state is displayed. Moreover, in each of the switching setting screens, manual operation buttons for selecting one of validation (ON) and invalidation (OFF) of the switching setting of the wireless LAN connection in the sleep state are displayed.

FIG. 16A shows a display example of a case where the switching setting of the wireless LAN connection in the sleep state is set to OFF. The screen in FIG. 16A does not display information currently displayed in the screens in FIG. 16B and FIG. 16C. Specifically, the information about the wireless LAN connected in the sleep state is not displayed. It should be noted that the information about the wireless LAN connected in the sleep state may be displayed by gray out instead of non-display.

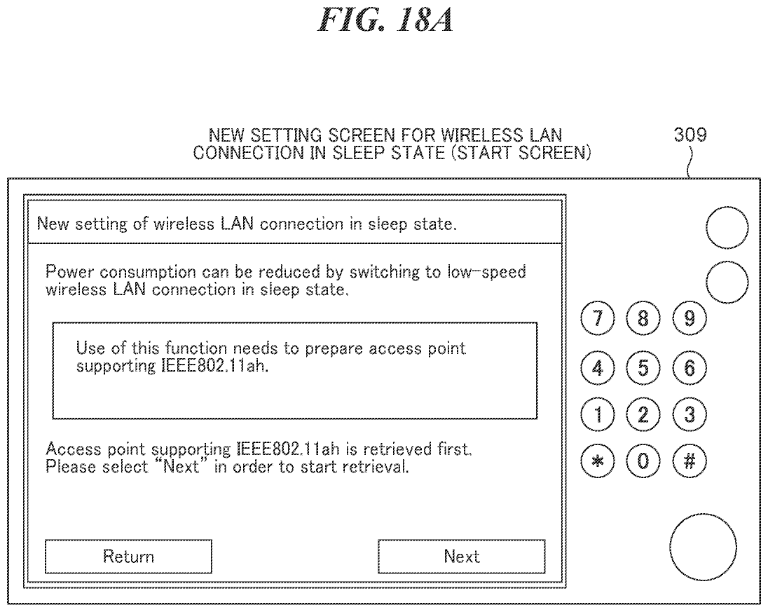

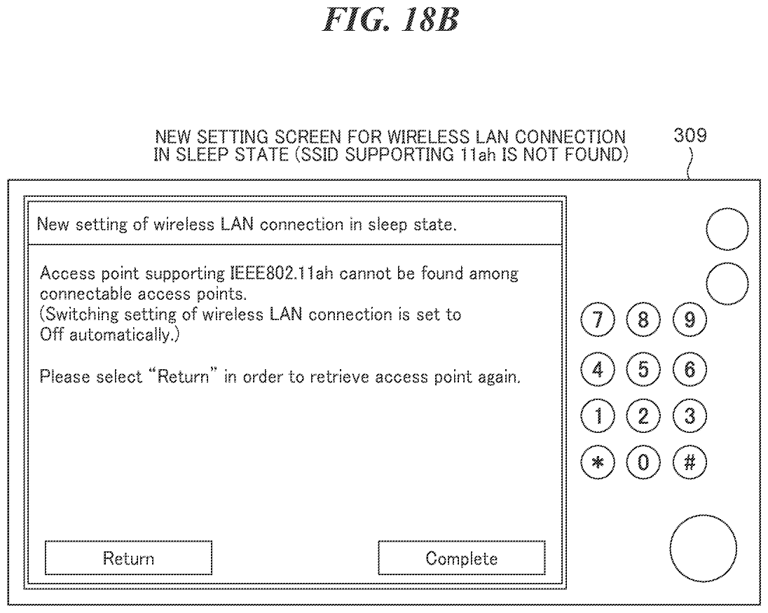

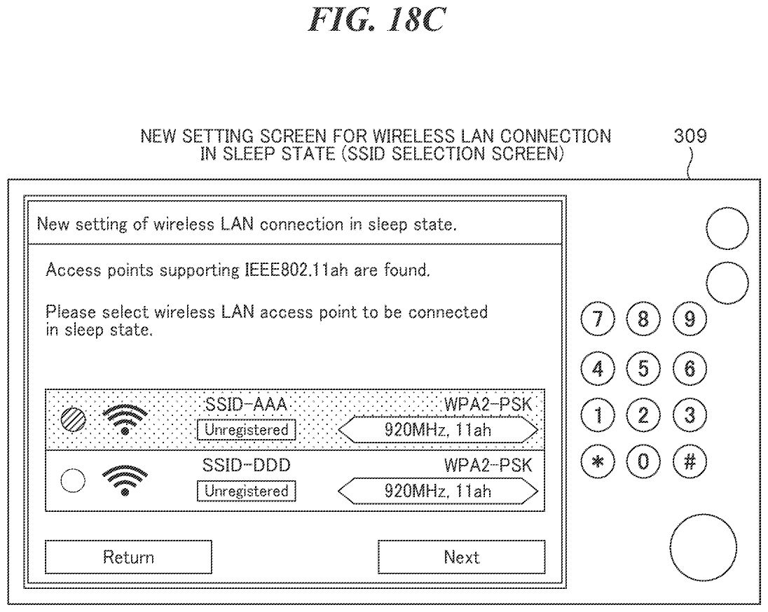

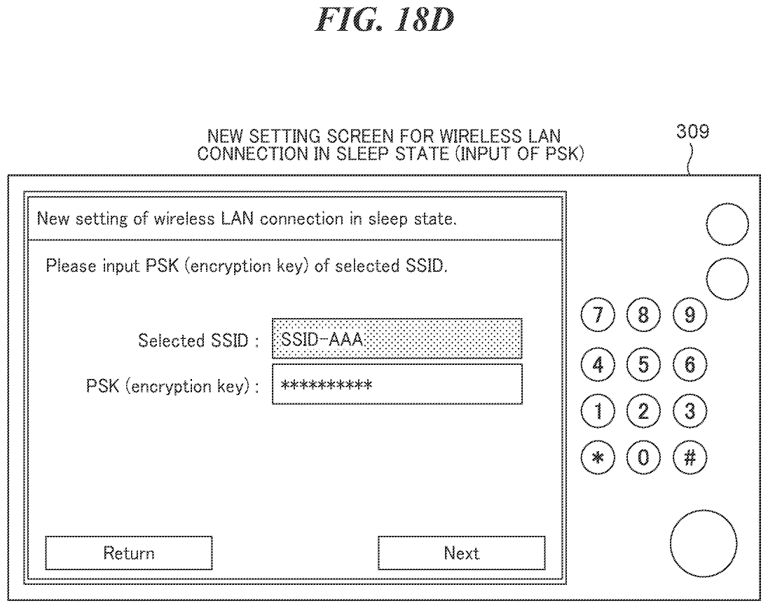

FIG. 16B shows a display example of a case where the switching setting of the wireless LAN in the sleep state is set to ON and the wireless LAN to be connected in the sleep state is not set up. When the wireless LAN to be connected in the sleep state is not set up, a message 1601 showing that the switching setting of the wireless LAN connection in the sleep state becomes OFF automatically is displayed. When a button 1602 with a message “New setting for wireless LAN connection in sleep state” is selected in the screen in FIG. 16B, the screen is changed to a new setting screen for the wireless LAN connection in the sleep state shown in FIG. 18A mentioned later.

FIG. 16C shows a display example of a case where the switching setting of the wireless LAN in the sleep state is set to ON, the wireless LAN to be connected in the sleep state has been set up and is connectable. In the screen in FIG. 16C, information 1603 about the wireless LAN connected in the sleep state and the button 1602 are displayed.

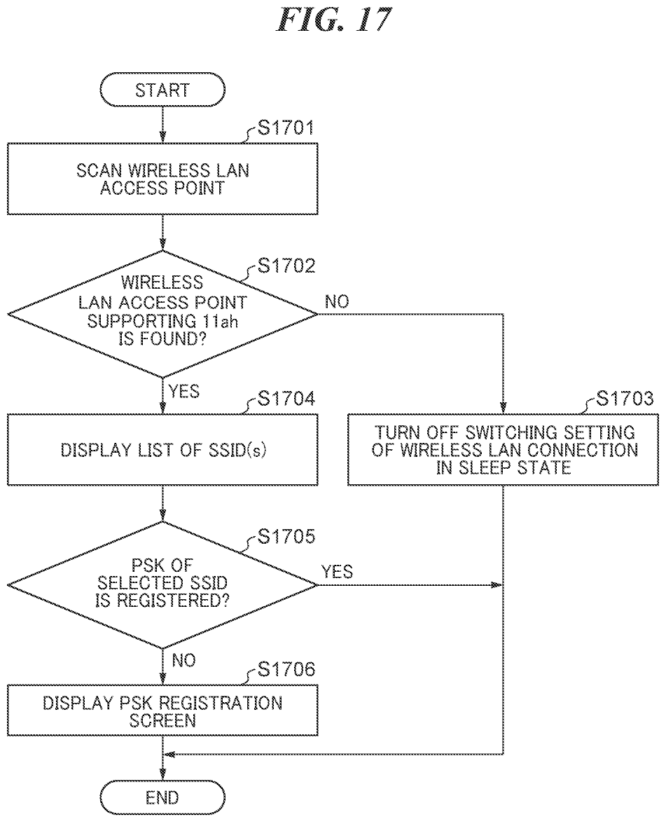

FIG. 17 is a flowchart showing a procedure of a wireless-LAN-connection setting process executed by the image forming apparatus 300 in FIG. 1 in the sleep state. The process in FIG. 17 is achieved because the main CPU 302 runs a program stored in the DRAM 306 etc.

FIG. 18A through FIG. 18D are views showing screen examples concerning the wireless LAN connection of the image forming apparatus in the sleep state. The process in FIG. 17 is executed when a “next” button is selected in the new setting screen for the wireless LAN connection in the sleep state shown in FIG. 18A, for example.

As shown in FIG. 17, the main CPU 302 first scans a wireless LAN access point supporting the 11ah connection through the wireless LAN module 700 (a step S1701). Next, the main CPU 302 determines whether a wireless LAN access point supporting the 11ah connection is found by the scan in the step S1701 (a step S1702).

As a result of the determination in the step S1702, when it is determined that a wireless LAN access point supporting the 11ah connection is not found by the scan in the step S1701, the process proceeds to a step S1703. In the step S1703, the main CPU 302 sets the switching setting of the wireless LAN connection in the sleep state to OFF. After that, the main CPU 302 displays the screen in FIG. 18B on the UI 309. In the screen in FIG. 18B, a message showing that a wireless LAN access point supporting the 11ah connection is not found is displayed. After that, this process is finished.

As a result of the determination in the step S1702, when it is determined that a wireless LAN access point supporting the 11ah connection is found by the scan in the step S1701, the process proceeds to a step S1704. In the step S1704, the main CPU 302 displays a list of SSIDs of wireless LAN access points found by the scan in the step S1701. Specifically, the main CPU 302 displays a screen in FIG. 18C that includes the list of SSIDs. The user selects a wireless LAN access point used for wireless communication in the sleep state from the displayed list of SSIDs. Next, the main CPU 302 determines whether PSK of the SSID selected in the screen in FIG. 18C has been registered in a step S1705.

When it is determined that the PSK of the selected SSID has been registered in the step S1705, this process is finished. When it is determined that the PSK of the selected SSID has not been registered in the step S1705, the main CPU 302 displays a PSK registration screen in FIG. 18D on the UI 309 (a step S1706) and finishes this process.

According to the above-mentioned embodiment, the switching setting screen that prompts a user to set the switching setting of the wireless LAN connection in the sleep state of the image forming apparatus 300 is displayed on the UI 309. Accordingly, the electric power consumption can be reduced using the 11ah connection according to a user's instruction without spoiling the usability of the wireless communication.

Although the configuration in which the image forming apparatus 300 is provided with the wireless LAN module 700 that supports both the wireless standards of IEEE802.11ah and IEEE802.11ac is described in this embodiment, the present invention is not limited to this configuration. For example, the image forming apparatus 300 may be provided with a first wireless LAN module that supports the wireless standard of IEEE802.11ah and a second wireless LAN module that supports the wireless standard of IEEE802.11ac. Also in such a configuration, the similar effect as the embodiment mentioned above can be obtained.

Although the configuration in which the screens shown in FIG. 8A through FIG. 8H, FIG. 16A through FIG. 16C, and FIG. 18A through FIG. 18D are displayed on the UI 309 is described in the above-mentioned embodiment, the present invention is not limited to this configuration. For example, these screens may be displayed on the input/output unit 606 of the terminal processing apparatus 600. Moreover, these screens may be displayed on a display unit of a mobile terminal, such as a smart phone or a tablet terminal, that is communicable with the image forming apparatus 300.

Next, an information processing apparatus and its control method according to a second embodiment of the present invention will be described. The second embodiment is basically identical to the first embodiment in the configuration and effect. In the meantime, the second embodiment gives priority to the reduction of the electric power consumption when the electric power state of the image forming apparatus 300 is the standby state. This is a different point from the first embodiment. Accordingly, descriptions about the duplicate configuration and effect are omitted, and different configuration and effect are described hereinafter.

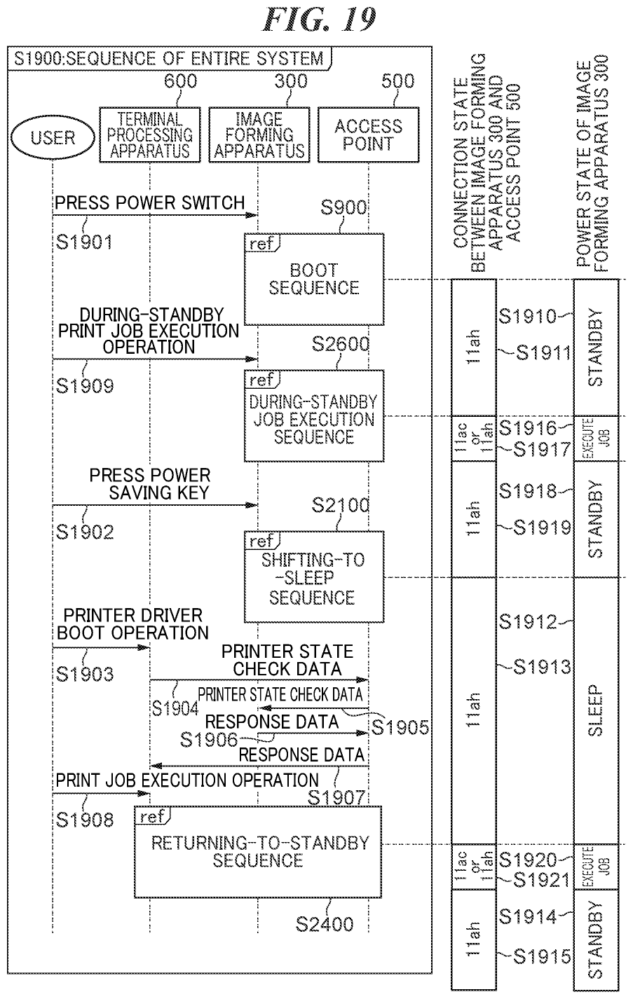

FIG. 19 is a view showing a relation among a sequence of an entire wireless communication system, which includes the image forming apparatus as the information processing apparatus in the second embodiment, an electric power state of the image forming apparatus, and a wireless LAN connection state between the image forming apparatus and an access point. It should be noted that FIG. 19 shows a case where the image forming apparatus 300 prints out as an example as with FIG. 2.

As shown in FIG. 19, a user presses the power switch of the image forming apparatus 300 in a step S1901 to boot the image forming apparatus 300 from an OFF state to an ON state. When the power switch is pressed, the boot sequence S900 in FIG. 9 mentioned above is executed. When the boot sequence S900 is completed, the electric power state of the image forming apparatus 300 turns into the standby state in a step S1910. At this time, the wireless LAN connection state of the image forming apparatus 300 is controlled by the 11ah connection (i.e., the wireless communication connection of the first communication function) in a step S1911 in order to reduce the electric power consumption by giving priority to reduction of the electric power consumption of the image forming apparatus 300.

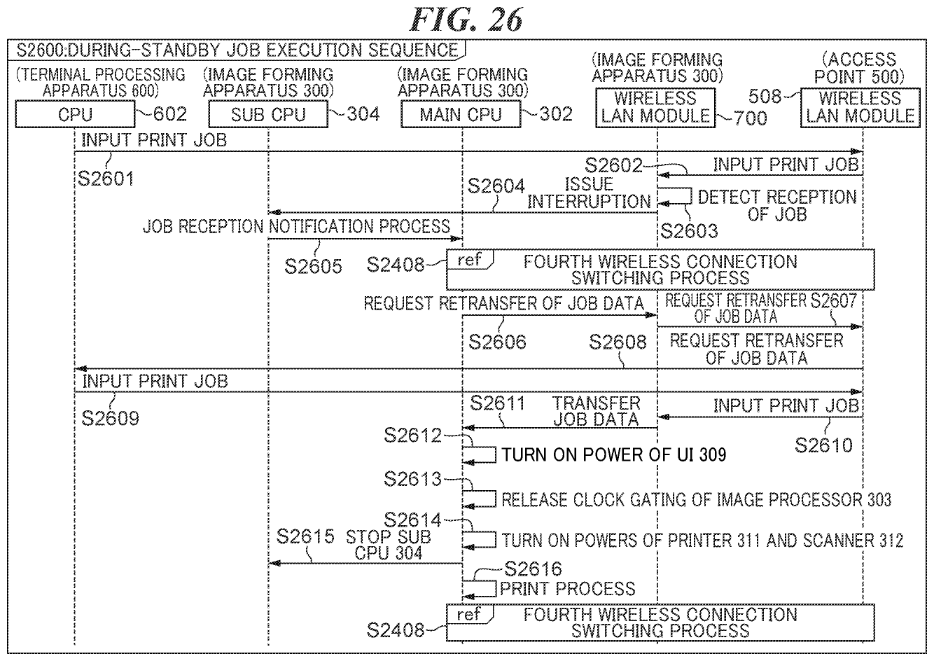

In a step S1909, the user operates the image forming apparatus 300 to execute a print job in order to print by the image forming apparatus 300 in the standby state. A during-standby job execution sequence S2600 is started by a trigger that is the input of the print job into the image forming apparatus 300 in the standby state. The during-standby job execution sequence S2600 is mentioned later by referring to FIG. 26. Then, in a step S1916, the electric power state of the image forming apparatus 300 becomes a print job executable state. At this time, as shown in a step S1917, the wireless LAN connection state of the image forming apparatus 300 is controlled by the 11ac connection or the 11ah connection in accordance with the communication speed of the terminal processing apparatus 600 that inputs the print job.

When the during-standby job execution sequence S2600 is completed, the electric power state of the image forming apparatus 300 turns into the standby state in a step S1918. At this time, the wireless LAN connection state of the image forming apparatus 300 is controlled by the 11ah connection in a step S1919.

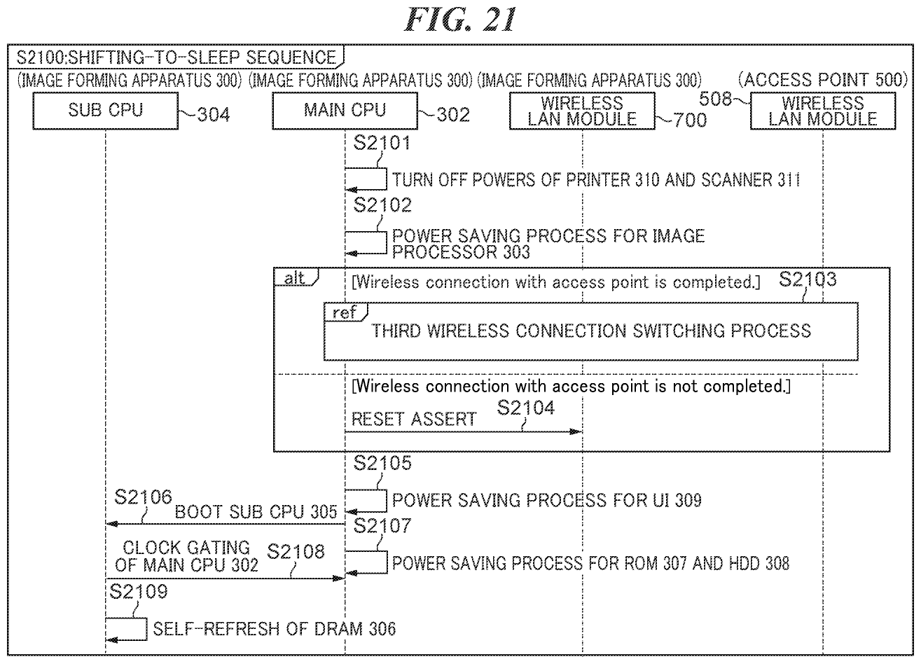

In a step S1902, the user presses the power saving key provided in the UI 309 of the image forming apparatus 300 in order to shift the image forming apparatus 300 to the sleep state. A shifting-to-sleep sequence S2100 is started by a trigger that is the press of the power saving key. The shifting-to-sleep sequence S2100 is mentioned later by referring to FIG. 21.

When the shifting-to-sleep sequence S2100 is completed, the electric power state of the image forming apparatus 300 turns into the sleep state in a step S1912. At this time, the wireless LAN connection state of the image forming apparatus 300 is controlled by the 11ah connection in a step S1913 in order to give priority to reduction of the electric power consumption (power saving) of the image forming apparatus 300.

In a step S1903, the user operates the terminal processing apparatus 600 to start a printer driver in order to print by the image forming apparatus 300. It should be noted that an IP address of the image forming apparatus 300 shall be beforehand registered into the printer driver in this embodiment.

In a step S1904, the terminal processing apparatus 600 transmits inquiry data for state confirmation to the IP address of the image forming apparatus 300. In a step S1905, the image forming apparatus 300 receives the inquiry data through the access point 500.

In a step S1906, the image forming apparatus 300 transmits data showing a printable state as a response to the data received in the step S1905 to the access point 500. In a step S1907, the terminal processing apparatus 600 receives this data through the access point 500.

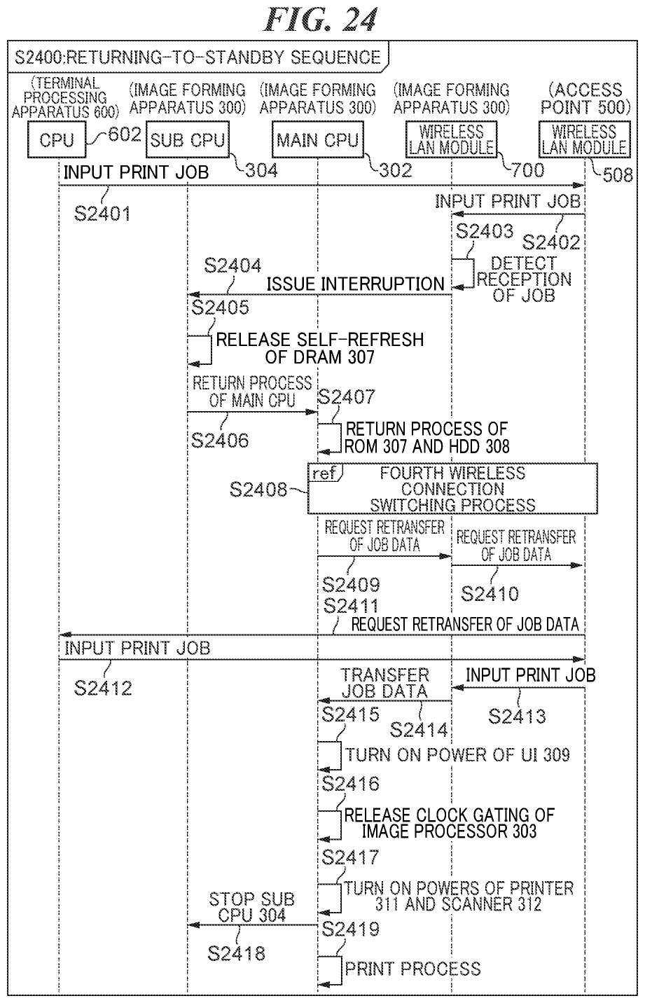

In a step S1908, the user operates the terminal processing apparatus 600 to execute a print job in order to print by the image forming apparatus 300. A returning-to-standby sequence S2400 is started by a trigger that is the input of the print job to the image forming apparatus 300 in the sleep state. The returning-to-standby sequence S2400 is mentioned later by referring to FIG. 24.

When the image forming apparatus 300 detects job reception in the returning-to-standby sequence S2400, the electric power state of the image forming apparatus 300 turns into a job execution state in a step S1920. At this time, as shown in a step S1921, the wireless LAN connection state of the image forming apparatus 300 is controlled by the 11ac connection or the 11ah connection in accordance with the communication speed of the terminal processing apparatus 600 that inputs the print job.

When the returning-to-standby sequence S2400 is completed, the electric power state of the image forming apparatus 300 turns into the standby state in a step S1914. At this time, the wireless LAN connection state of the image forming apparatus 300 is controlled by the 11ah connection in a step S1915. As mentioned above, the image forming apparatus 300 switches the wireless LAN connection state suitably in accordance with the electric power state.

The configuration of the image forming apparatus 300 in the second embodiment is the same as that of the image forming apparatus 300 in the first embodiment shown in FIG. 3 mentioned above. However, the control concerning the wireless LAN module 700 in the image forming apparatus 300 in the second embodiment differs from that of the image forming apparatus 300 in the first embodiment. Hereinafter, the control of the wireless LAN module 700 in the image forming apparatus 300 in the second embodiment is described.

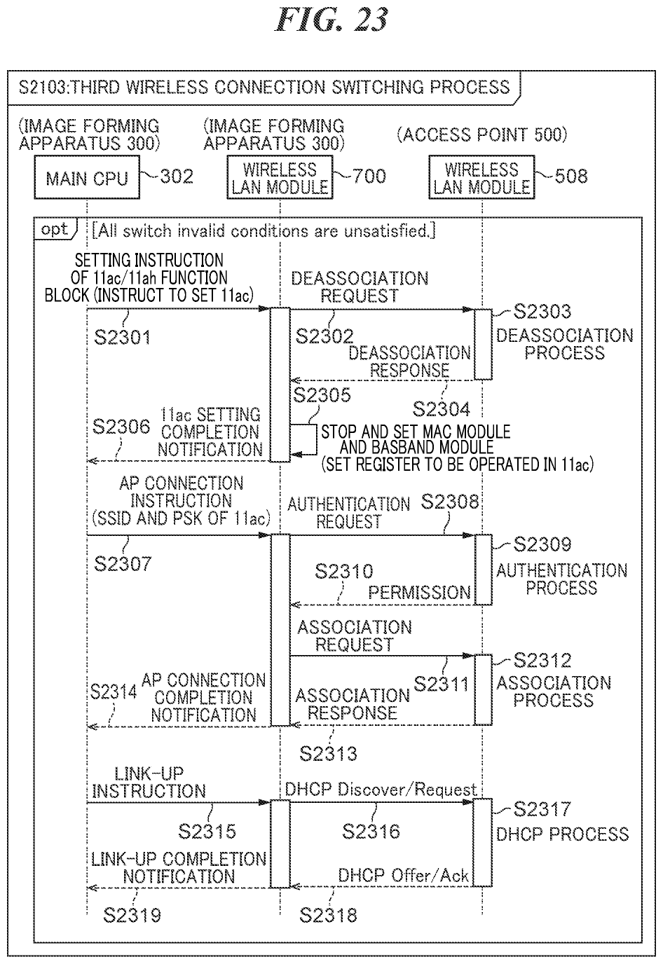

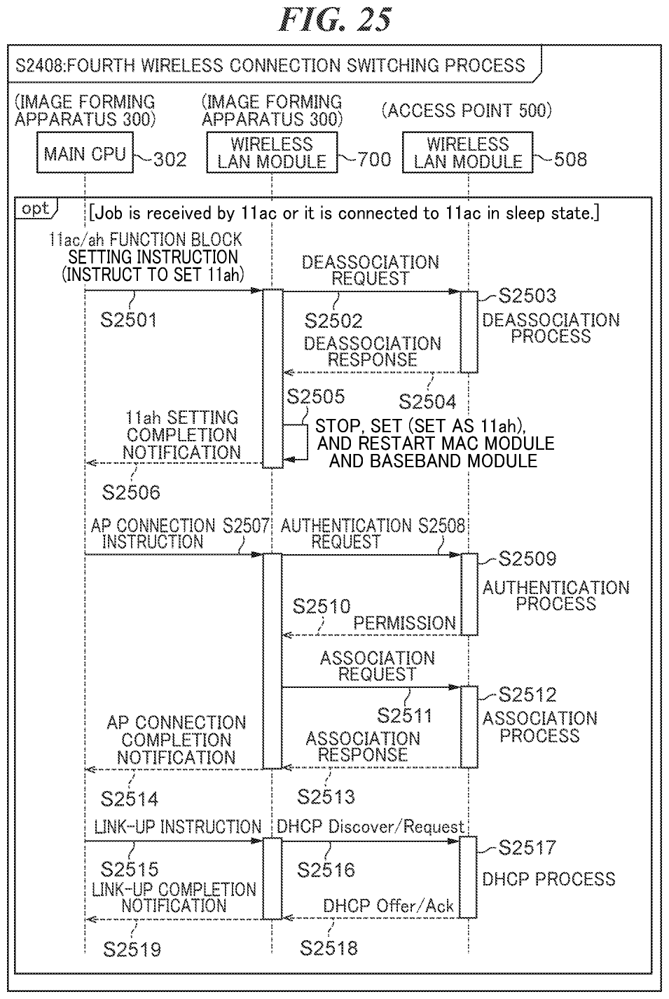

When the image forming apparatus 300 communicates at a low communication speed by giving priority to the reduction of the electric power consumption, the wireless LAN module 700 is controlled to be connectable to an external apparatus through the 11ah connection. Moreover, when the image forming apparatus 300 communicates at a high communication speed by giving priority to the communication sped, the wireless LAN module 700 is controlled to be connectable to an external apparatus through the 11ac connection. Each control is performed by the main CPU 302. In this way, the main CPU 302 functions as a control unit that switches the 11ah connection (start of the first communication function) and its stop and that switches the 11ac connection (start of the second communication function) and its stop in the wireless LAN module 700. This control is mentioned later by referring to FIG. 23 and FIG. 25.

The low speed communication is performed in a case of checking a status of a printer connected to the image forming apparatus 300 through the wireless network (when a printer status is checked), for example. Moreover, the low speed communication is performed in a case of searching for a printer that is newly connected to the wireless network (when a printer search packet is transmitted). In addition, the low speed communication is performed in a case of updating a display screen (RUI: Remote User Interface) displayed on the terminal processing apparatus 600 that is connected through the wireless LAN (when an RUI update packet is transmitted). In this way, the low speed communication is performed when immediacy between the image forming apparatus 300 and the access point 500 is unnecessary (dispensable). Even when a print job is input from the terminal processing apparatus 600, the image forming apparatus 300 is connected through the 11ah connection in the low speed communication.

In the meantime, the high speed communication is performed in a case where a print job is input from the terminal processing apparatus 600 that is connected to the image forming apparatus 300 through the wireless LAN, for example. In addition, the high speed communication is performed in a case where document information (for example, a print preview image or a document image) that is displayed on the RUI of the terminal processing apparatus 600 that is connected to the wireless network through the 11ac connection is transmitted from the image forming apparatus 300. In this way, the high speed communication is performed when the immediacy between the image forming apparatus 300 and the access point 500 is necessary.

As mentioned above, in the wireless LAN module 700, the switching between the 11ah connection and its stop and the switching between the 11ac connection and its stop are performed in accordance with predetermined information concerning the necessity of the immediacy between the image forming apparatus 300 and the access point 500. Thereby, the connection between the image forming apparatus 300 and the access point 500 is suitably switched between the 11ah connection and the 11ac connection in accordance with the size of the data transmitted and received, and accordingly, quick wireless communication becomes available. The switching control in the wireless LAN module 700 is performed by the main CPU 302 as mentioned above.

Particularly, when the 11ah connection is valid and the 11ac connection stops, the image forming apparatus 300 receives a packet mentioned later through the 11ah connection. Then, when the received packet includes the predetermined information (necessity of the immediacy), the wireless LAN module 700 enables the 11ac connection and wirelessly communicates with the access point 500 through the 11ac connection concerned. Thereby, the quick wireless communication becomes available, which is capable of sufficiently coping with the situation where the immediacy between the image forming apparatus 300 and the access point 500 is necessary.

When the main CPU 302 wirelessly communicates with the access point 500 through the 11ac connection, the 11ah connection may be in the connectable state or may stop. When the 11ah connection is in the connectable state, the communication using the 11ah connection becomes available. In the meantime, when the 11ah connection stops, the electric power consumption of the image forming apparatus 300 is reduced by the stop.

Moreover, when completing the wireless communication with the access point 500 through the 11ac connection, the image forming apparatus 300 shifts to the state where the 11ah connection is available and the 11ac connection stops, namely, returns to an initial state. Thereby, the electric power consumption of the image forming apparatus 300 can be reduced in the standby state and sleep state, for example.

Moreover, when the received packet does not include the predetermined information, the image forming apparatus 300 wirelessly communicates with the access point 500 through the 11ah connection while keeping the state where the 11ah connection is available and the 11ac connection stops. Thereby, the electric power consumption of the image forming apparatus 300 can be reduced under the situation where the immediacy between the image forming apparatus 300 and the access point 500 is unnecessary.

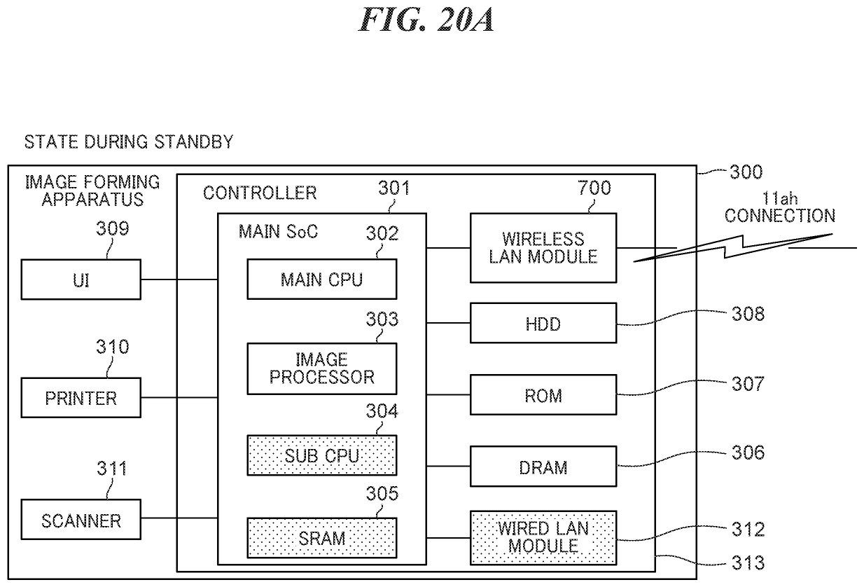

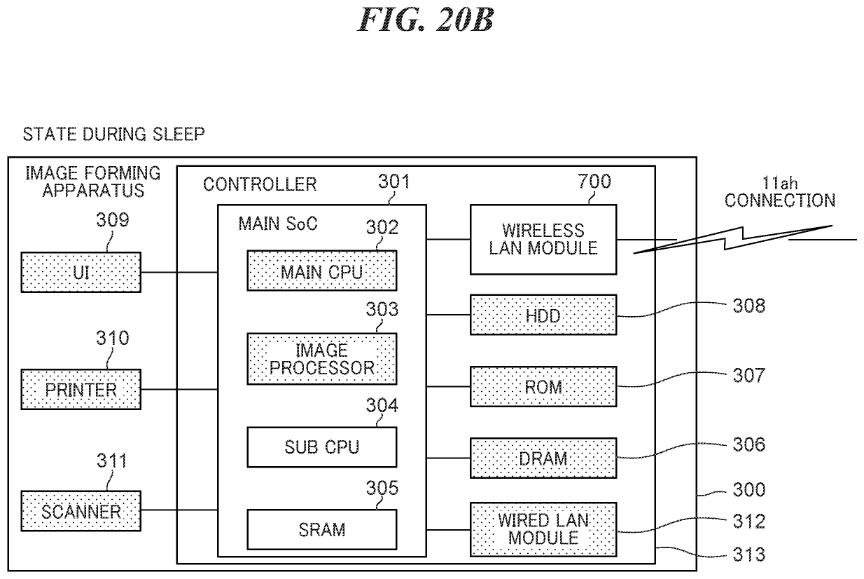

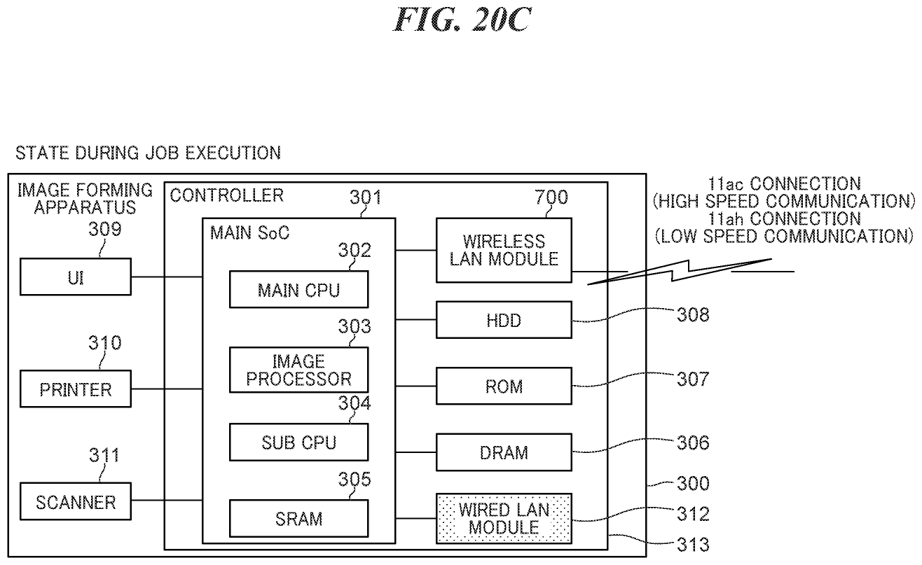

FIG. 20A through FIG. 20C are schematic views showing states of blocks of the image forming apparatus in the second embodiment in respective operating states. FIG. 20A shows a case where the operating state of the image forming apparatus is the standby state. FIG. 20B shows a case where the operating state of the image forming apparatus is the sleep state. FIG. 20C shows a case where the operating state of the image forming apparatus is the job execution state. Hereinafter, summaries of power saving control and return control of each block will be described.

In the sleep state, the sub CPU 304 controls the entire image forming apparatus 300 instead of the main CPU 302. Accordingly, the main CPU 302 controls the sub CPU 304 to be in a clock-off state in the standby state shown in FIG. 20A that does not need the control by the sub CPU 304. The SRAM 305 is the program area and work area of the sub CPU 304. Accordingly, the main CPU 302 controls the SRAM 305 to be in the clock-off state in the standby state (i.e., the clock-off state of the sub CPU 304).

The wired LAN module 312 is always controlled to be in the power saving mode in this embodiment. This is because this embodiment presupposes that a wireless LAN is selected in the network selection screen of the user menu shown in FIG. 8A.

When the wired LAN is not selected in the network selection screen, the wired LAN module 312 is not used. Accordingly, the main CPU 302 controls the wired LAN module 312 to be in a reset state or a power OFF state. The wireless LAN module 700 gives priority to the low power consumption in the standby state. Accordingly, the main CPU 302 controls the wireless LAN module 700 to use the 11ah connection. This control method is mentioned later by referring to FIG. 23 and FIG. 25.

In the sleep state shown in FIG. 20B, the sub CPU 304 controls the entire image forming apparatus 300 instead of the main CPU 302 as mentioned above. Accordingly, the sub CPU 304 operates by a program developed to the SRAM 305 in the sleep state and controls the entire image forming apparatus 300.

Moreover, the respective blocks are controlled to be in the power saving states in the sleep state as follows. Since a heavy load calculation process is not executed, the main CPU 302 is controlled by the sub CPU 304 to be in the power saving state. Since the image process and job process are not executed, the image processor 303, printer 310, and scanner 311 are controlled by the main CPU 302 to be in the power saving state.

Since the image forming apparatus 300 is not operated by the user, the UI 309 is controlled by the main CPU 302 to be in the power saving state. Since all the program area and work area of the sub CPU 304 are reserved in the SRAM 305, the HDD 308 and ROM 307 are controlled by the main CPU 302 to be in the power saving state. Moreover, the DRAM 306 is controlled by the sub CPU 304 to be in a self-refresh state. The wireless LAN module 700 gives priority to the low power consumption (power saving) in the sleep state as with the standby state.

Since the main CPU 302 and sub CPU 304 share the process concerning a job operation in the job execution state shown in FIG. 20C, the both CPUs are operating. Moreover, the HDD 308, ROM 307, and DRAM 306 are also operating interlocking with the operations of the main CPU 302 and sub CPU 304.

Moreover, since image data read from the scanner 311 and image data sent to the printer 310 are processed in the job execution state, the image processor 303 and SRAM 305 are operating, respectively. Moreover, since the wireless LAN module 700 is operating with the high speed communication or the low speed communication in the job execution state, the wireless LAN module 700 is controlled by the 11ac connection or the 11ah connection in accordance with the communication speed.

FIG. 21 is a view showing the shifting-to-sleep sequence of the image forming apparatus in the second embodiment. The shifting-to-sleep sequence S2100 is started by the trigger that is the press of the power saving key of the image forming apparatus 300 in the step S1902 (see FIG. 19) as mentioned above. It should be noted that the shifting-to-sleep sequence may be started when the CPU 302 detects a timer interrupt signal besides the press of the power saving key. In this embodiment, the shifting-to-sleep sequence shall begin by the press of the power saving key.

In a step S2101, the main CPU 302 controls to turn OFF the powers of the printer 310 and scanner 311. In a step S2102, the main CPU 302 executes a clock gating process as a power saving process for the image processor 303.

In a step S2103, the main CPU 302 executes a third wireless connection switching process to the wireless LAN module 700. The process in the step S2103 is executed only when the wireless connection between the image forming apparatus 300 and the access point 500 through the wireless LAN module 700 is completed. In the meantime, when the wireless connection with the access point 500 is not completed, the main CPU 302 executes a reset assert to the wireless LAN module 700 in a step S2104. The process in the step S2103 is mentioned later by referring to FIG. 23.

In a step S2105, the main CPU 302 executes the power saving process by controlling to turn off a back light of the UI 309, etc. In a step S2106, the main CPU 302 develops a program of the sub CPU 304 to the SRAM 305 and executes the internal reset release to the sub CPU 304 to boot the sub CPU 304.

In a step S2107, the main CPU 302 executes a power gating process as the power saving process for the ROM 307 and HDD 308. In a step S2108, the sub CPU 304 executes the clock gating process to the main CPU 302. Thereby, the main CPU 302 becomes in a stopped state. In a step S2109, the sub CPU 304 brings the DRAM 306 to a self-refresh state.

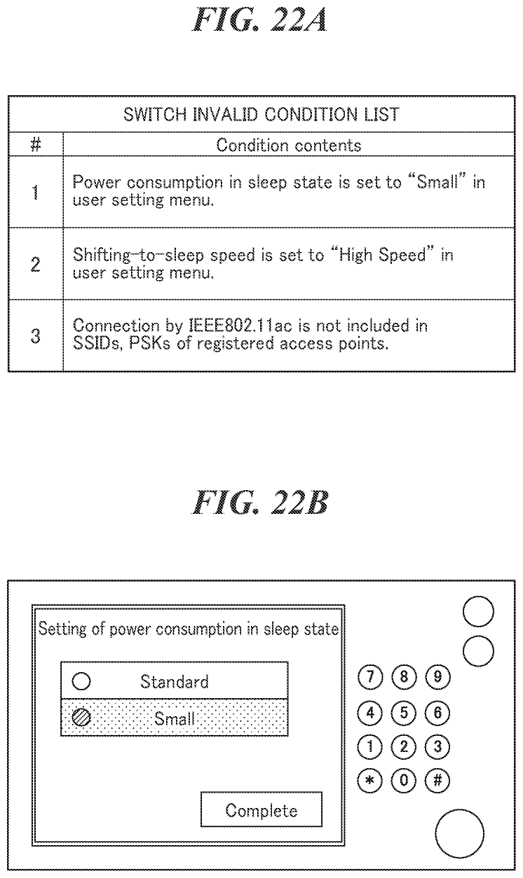

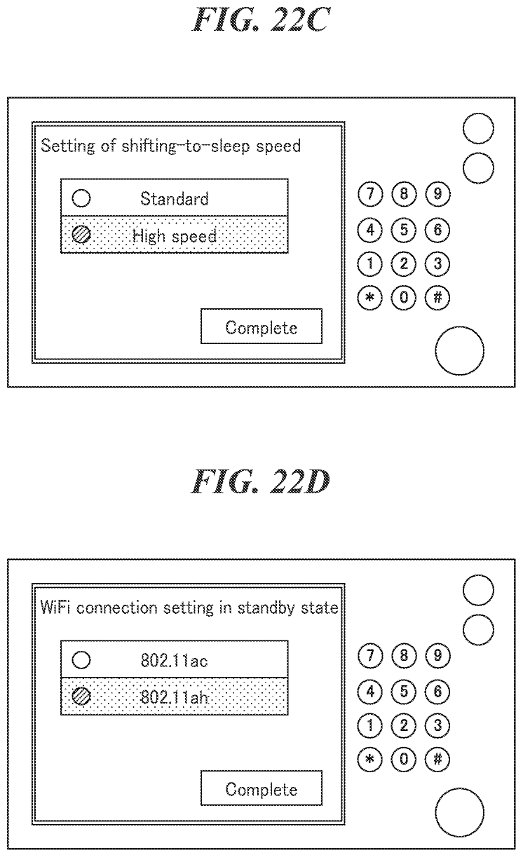

FIG. 22A through FIG. 22D are views showing screen examples concerning the sleep state and the standby state of the image forming apparatus in the second embodiment. FIG. 22A shows a list of “switch invalid conditions” that invalidate the switching of the wireless connection by the third wireless connection switching process in the step S2103 mentioned above. FIG. 22B shows an example of a setting screen of power consumption in the sleep state. FIG. 22C shows an example of a setting screen of a speed in shifting to the sleep state. FIG. 22D shows an example of a WiFi connection setting screen in the standby state.

As shown in FIG. 22A, the list includes three switch invalid conditions, for example. A first switch invalid condition shows a case where the sleep electric power setting, which is set to “standard” or “small”, is set to “standard” in a user setting menu. An example of the screen of the user setting menu under the first switch invalid condition is shown in FIG. 22B. In the description, the selection item names “standard” and “small” are examples. The “standard” may be expressed as “large”. The first switch invalid condition is a condition for controlling not to switch to the 11ac connection when it is necessary to reduce the sleep electric power.

A second switch invalid condition shows a case where the speed setting in shifting to the sleep state, which is set to “standard” or “high speed”, is set to “high speed” in the user setting menu. In the first embodiment, the 11ah connection is used in the sleep state. As compared with this, when the 11ac connection is used even in the sleep state, the “high speed” is set because it is unnecessary to switch the shifting-to-sleep speed. An example of the screen of the user setting menu under the second switch invalid condition is shown in FIG. 22C. In the description, the selection item names “standard” and “high speed” are examples. The “standard” may be expressed as “low speed” or “slow”. The second switch invalid condition is a condition for controlling not to switch to the 11ac connection when it is wanted to heighten the shifting-to-sleep speed (it is wanted to shorten a shifting period).

A third switch invalid condition shows a case where the SSIDs and PSKs of the access points registered beforehand do not include the 11ac connection. When a WiFi connection connected in the standby state is directly designated, it can be set up from the user setting menu shown in FIG. 22D. When the 11ah connection is used in the standby state, there is a merit of reducing the electric power consumption in the standby state. However, an execution speed (productivity) of a job may be lowered because the communication speed is lowered with regard to some pieces of information received in the standby state. Accordingly, the WiFi connection can be compulsorily set up on the screen shown in FIG. 22D in accordance with a user's demand.

FIG. 23 is a view showing a sequence of the third wireless connection switching process. The third wireless connection switching process shown in FIG. 23 is similar to the first wireless connection switching process in FIG. 13 mentioned above. The third wireless connection switching process in steps S2301 through S2319 shown in FIG. 23 is executed as a connection switching process to the 11ac connection in shifting to the sleep state only when all the items of the switch invalid conditions shown in FIG. 22A are unsatisfied. Accordingly, when at least one condition is satisfied, the process in the steps S2301 through S2319 is not executed.

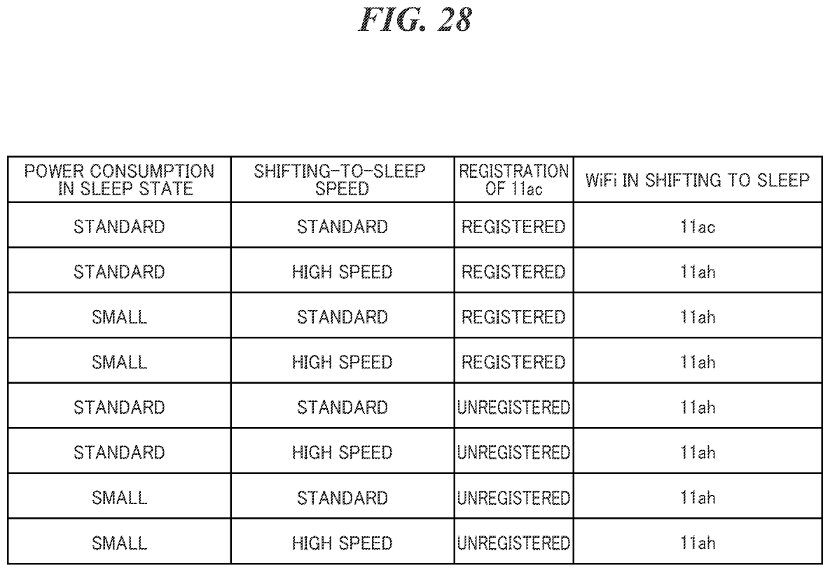

The connection switching state in the step S2103 is shown in FIG. 28. FIG. 28 is a table showing a relation between a sleep electric power setting, a shifting-to-sleep speed, registration of the 11ac connection, and WiFi connection in shifting to the sleep state. As shown in a second line from a top in the table shown in FIG. 28, when the 11ac connection is registered and the 11ac connection is used as the WiFi connection in shifting to the sleep state, the sleep electric power setting becomes “standard” and the shifting-to-sleep speed also becomes “standard”.

As shown in FIG. 23, in the step S2301, the main CPU 302 sends out a setup instruction of the 11ac/ah function block 705 to the wireless LAN module 700. In the step S2301, the setup instruction of the 11ac connection is sent out as an example. In steps S2302 through S2304, the wireless LAN module 700 performs the deassociation process (the disconnection process) for disconnecting from the access point 500. The process in the steps S2302 through S2304 is based on the IEEE802.11 standard and is well-known.

When the deassociation process is completed, the CPU 702 of the wireless LAN module 700 sets up the register in a step S2305 so that the blocks of the 11ac/ac function block 705 can operate by the 11ac connection. The setup period of the register setting here can be shortened by using only difference set values between the 11ac connection and 11ah connection.

In a step S2306, the wireless LAN module 700 sends out a 11ac setting completion notification to the main CPU 302. In a step S2307, the main CPU 302 sends out the AP connection instruction (an instruction connecting to the access point 500) to the wireless LAN module 700. In this step S2307, the main CPU 302 notifies the wireless LAN module 700 of the SSID and PSK of the registered 11ac connection, for example.

In steps S2308 through S2313, the CPU 702 of the wireless LAN module 700 controls the 11ac/ah function block 705 and executes the authentication process and the association process based on the IEEE802.11 standard with the access point 500. The steps S2308 through S2310 correspond to the authentication process, and the steps S2311 through S2313 correspond to the association process. The authentication process and association process in the steps S2308 through S2313 are based on the IEEE802.11 standard and are well-known.

In a step S2314, after completing the association process, the wireless LAN module 700 sends out the AP (access point) connection completion notification to the main CPU 302. In a step S2315, the main CPU 302 sends out the link-up instruction (DHCP Discover, the instruction to link-up to the network) to the wireless LAN module 700.

In steps S2316 through S2318, the CPU 702 of the wireless LAN module 700 controls the 11ac/ah function block 705 to obtain an IP address from a DHCP server (not shown) through the access point 500. In the step S2319, the wireless LAN module 700 sends out the IP address together with the link-up completion notification to the main CPU 302.

Since the network connection is achieved by the 11ac connection by performing the shifting-to-sleep sequence (including the third wireless connection switching process in FIG. 23) shown in FIG. 21, the quick wireless communication becomes available, which is capable of sufficiently coping with the situation where the immediacy between the image forming apparatus 300 and the access point 500 is necessary as compared with the 11ah connection.

It should be noted that the message communications in the steps S2306, S2307, S2314, and S2315 may be gathered to the two steps S2301 and S2319 in order to shorten a switching period. That is, the CPU 702 of the wireless LAN module 700 may be constituted so as to perform required processes in succession until the step S2319 after the reception in the step S2301. In this case, the main CPU 302 preferably sends out the information, such as the SSID and PSK, to the wireless LAN module 700 in the step S2301.

FIG. 24 is a view showing a returning-to-standby sequence of the image forming apparatus in the second embodiment. The returning-to-standby sequence S2400 is started by the trigger that is the print job execution operation to the terminal processing apparatus 600 in the step S1908 (see FIG. 19). In steps S2401 through S2404, when a job is input into the image forming apparatus 300 from the terminal processing apparatus 600 through the IP network, the wireless LAN module 700 that receives job data transmits an interrupt signal to the sub CPU 304. This starts the returning-to-standby sequence.

It should be noted that the returning-to-standby sequence may be started when the sub CPU 304 detects timer interruption, power saving key interruption, human sensor interruption, etc. besides the job reception interruption. In this embodiment, the returning-to-standby sequence shall begin by the job reception.

In a step S2405, the sub CPU 304 that received the interrupt signal from the wireless LAN module 700 releases the self-refresh of the DRAM 306. In a step S2406, the sub CPU 304 returns the main CPU 302 by releasing the clock gating of the main CPU 302. At this time, the sub CPU 304 notifies the main CPU 302 that the return is due to the job reception through the wireless LAN.

In a step S2407, the main CPU 302 releases the power gating process for the ROM 307 and HDD 308. In a step S2408, the main CPU 302 executes a fourth wireless connection switching process to the wireless LAN module 700. The process in the step S2408 is mentioned later by referring to FIG. 25.

In steps S2409 through S2411, the main CPU 302 requests retransfer of the job data from the terminal processing apparatus 600 through the wireless LAN module 700 and access point 500.

In steps S2412 through S2414, the terminal processing apparatus 600 that received the retransfer request transmits the print job to the image forming apparatus 300 again. The job data that is received by the image forming apparatus 300 is stored in the DRAM 306 or the HDD 308.

In a step S2415, the main CPU 302 controls to turn ON the power of the UI 309. Thereby, the back light of UI 309 lights and the UI 309 returns to the normal state. In a step S2416, the main CPU 302 executes a process for releasing the clock gating of the image processor 303. Thereby, the image processor 303 returns to the normal state.

In a step S2417, the main CPU 302 controls to turn ON the powers of the printer 310 and scanner 311. Thereby, the printer 310 and scanner 311 return to the normal state. In a step S2418, the main CPU 302 stops the operation of the sub CPU 304. In a step S2419, the main CPU 302 executes a print process using the job data received in the step S2414.

FIG. 25 is a view showing a sequence of the fourth wireless connection switching process. The fourth wireless connection switching process shown in FIG. 25 is similar to the second wireless connection switching process in FIG. 15 mentioned above.

Steps S2501 through S2519 shown in FIG. 25 are steps for executing the fourth wireless connection switching process and are executed when the connection is switched to the 11ac connection in the shifting-to-sleep sequence or when a job is received through the 11ac connection. That is, the steps S2501 through S2519 are executed only when the steps S2301 through S2319 are executed.

In the step S2501, the main CPU 302 sends out a setup instruction of the 11ac/ah function block 705 to the wireless LAN module 700. In the step S2501, the setup instruction of the 11ah connection is sent out as an example.

In steps S2502 through S2504, the wireless LAN module 700 performs the deassociation process (the disconnection process) for disconnecting from the access point 500. The process in the steps S2502 through S2504 is based on the IEEE802.11 standard and is well-known.

When the deassociation process is completed, the CPU 702 of the wireless LAN module 700 sets up the register in a step S2505 so that the blocks of the 11ac/ah function block 705 can operate by the 11ah connection. The setup period of the register setting here can be shortened by using only difference set values between the 11ac connection and 11ah connection.

In a step S2506, the wireless LAN module 700 sends out the 11ah setting completion notification to the main CPU 302. In a step S2507, the main CPU 302 sends out the AP connection instruction (an instruction connecting to the access point 500) to the wireless LAN module 700. In this step S2507, the main CPU 302 notifies the wireless LAN module 700 of the SSID and PSK of the registered 11ac connection, for example.

In steps S2508 through S2513, the CPU 702 of the wireless LAN module 700 controls the 11ac/ah function block 705 and executes the authentication process and the association process based on the IEEE802.11 standard with the access point 500. The steps S2508 through S2510 correspond to the authentication process, and the steps S2511 through S2513 correspond to the association process. The authentication process and association process in the steps S2508 through S2513 are based on the IEEE802.11 standard and are well-known.

In a step S2514, after completing the association process, the wireless LAN module 700 sends out the AP (access point) connection completion notification to the main CPU 302. In a step S2515, the main CPU 302 sends out the link-up instruction (DHCP Discover, the instruction to link-up to the network) to the wireless LAN module 700.

In steps S2516 through S2518, the CPU 702 of the wireless LAN module 700 controls the 11ac/ah function block 705 to obtain an IP address from a DHCP server (not shown) through the access point 500. In the step S2519, the wireless LAN module 700 sends out the IP address together with the link-up completion notification to the main CPU 302.

Since the network connection is achieved by the 11ac connection when returning to the standby state from the sleep state by performing the returning-to-standby sequence (including the fourth wireless connection switching process in FIG. 25) shown in FIG. 24, the electric power consumption is reduced as compared with the 11ac connection.

It should be noted that the message communications in the steps S2506, S2507, S2514, and S2515 may be gathered to the two steps S2501 and S2519 in order to shorten a switching period. That is, the CPU 702 of the wireless LAN module 700 may be constituted so as to perform required processes in succession until the step S2519 after the reception in the step S2501. In this case, the main CPU 302 preferably sends out the information, such as the SSID and PSK, to the wireless LAN module 700 in the step S2501.

FIG. 26 is a view showing the during-standby job execution sequence of the image forming apparatus. The sequence S2600 shown in FIG. 26 is executed when a print-job execution operation is applied in a case where the image forming apparatus 300 is in the standby state. In this embodiment, even when a job is input under the standby state, the wireless connection during execution of the job is switched depending on whether the 11ah connection or the 11ac connection is used.

In steps S2601 through S2604, when a job is input into the image forming apparatus 300 from the terminal processing apparatus 600 through the IP network, the CPU 702 that received a packet sends out an interrupt signal to the sub CPU 304. Thereby, an operation for executing the job is started.

The operation for executing the job may be started when the sub CPU 304 detects timer interruption, power saving key interruption, human sensor interruption, or the like besides the job reception interruption. In this embodiment, the print process as the operation for executing the job shall be started by the job reception.

In a step S2605, the sub CPU 304 notifies the main CPU 302 of the job reception. In a step S2408, the main CPU 302 executes the fourth wireless connection switching process shown in FIG. 25 to the wireless LAN module 700. In steps S2606 through S2608, the main CPU 302 requests retransfer of the job data from the terminal processing apparatus 600 through the wireless LAN module 700 and access point 500.

In steps S2609 through S2611, the terminal processing apparatus 600 that received the retransfer request transmits the print job to the image forming apparatus 300 again. The job data that is received by the image forming apparatus 300 is stored in the DRAM 306 or the HDD 308.

In a step S2612, the main CPU 302 controls to turn ON the power of the UI 309. Thereby, the back light of UI 309 lights and the UI 309 returns to the normal state. In a step S2613, the main CPU 302 executes the process for releasing the clock gating of the image processor 303. Thereby, the image processor 303 returns to the normal state.

In a step S2614, the main CPU 302 controls to turn ON the powers of the printer 310 and scanner 311. Thereby, the printer 310 and scanner 311 return to the normal state. In a step S2418, the main CPU 302 stops the operation of the sub CPU 304.

In a step S2616, the main CPU 302 executes the print process using the job data received in the step S2611. After executing the step S2616, the fourth wireless connection switching process (the step S2408) is executed. Since the fourth wireless connection switching process is mentioned above, the description is omitted.

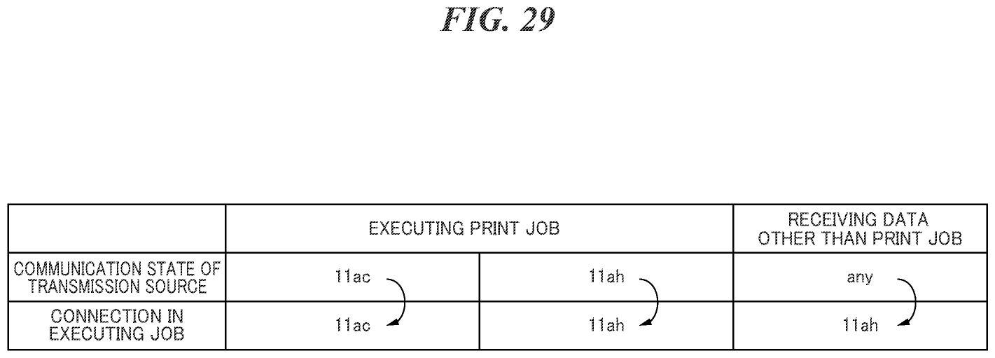

Next, the WiFi connection state in receiving a job during the standby state is described by referring to FIG. 29. FIG. 29 is a table describing a connection state of a transmission source in receiving a job and a connection state in executing the job.

As shown in FIG. 29, when the transmission source uses the 11ac connection in receiving the print job in the standby state, the 11ac connection is kept as-is. In the meantime, when the transmission source uses the 11ah connection in receiving the print job in the standby state, the 11ah connection is kept as-is. Moreover, when a job other than a print job is received in the standby state, the 11ah connection is always used.

The image forming apparatus 300 configured as mentioned above can reduce the electric power consumption in the sleep state and the standby state by using the 11ah connection. Moreover, the image forming apparatus 300 can perform a job operation while keeping the 11ah connection state. In this case, the electric power consumption during the job operation can be also reduced. Moreover, the image forming apparatus 300 can use the 11ac connection with regard to some kinds of job operations. Thereby, the quick wireless communication in accordance with the kinds of job operations becomes available.

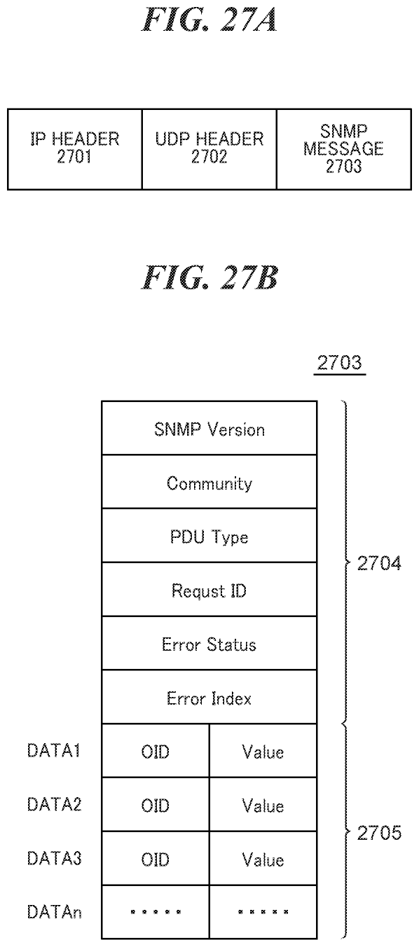

FIG. 27A and FIG. 27B are views describing a means for determining whether communication of the job in the fourth wireless connection switching process is connected by either the 11ah connection or the 11ac connection. FIG. 27A is a view describing a structure of a UDP (User Datagram Protocol) of an SNMP (Simple Network Management Protocol) used for determining a kind of wireless connection. It should be noted that the SNMP is a protocol for monitoring and managing an IP network.

FIG. 27B is a view showing an internal structure of an SNMP message. In the image forming apparatus 300, the switching between the 11ah connection and its stop and the switching between the 11ac connection and its stop are determined (hereinafter referred to as “switching determination”) on the basis of the SNMP. Thereby, the connection state can be suitably switched depending on a use state of the image forming apparatus 300. Hereinafter, the switching determination is described.

As shown in FIG. 27A, the UDP consists of an IP header 2701, an UDP header 2702, and an SNMP message 2703. Communication by the SNMP is performed between a manager and an agent. In this embodiment, the manager shall be the access point 500 as an example in order to facilitate understanding. Moreover, the agent shall be the terminal processing apparatus 600 that transmits a print job etc. to the image forming apparatus 300 and access point 500.

An SNMP header 2704 shown in FIG. 27B includes predetermined information corresponding to a request from the manager. Moreover, VB (Variable Bindings) 2705 consist of a plurality of data sets each of which consists of an OID (Object ID) and a value. The information about the switching determination can be included in the VB 2705. Then, the information enables the switching determination.

The manager requests necessary information from the agent by using a PDU (Protocol Data Unit) called “Get Request”. The agent notifies the manager using Trap PDU in response to the request. Usages of the first and second data sets of the VB 2705 transferred by the PUD are reserved, and arbitrary information can be stored from the third data set.

Hereinafter, a case where a job is executed from the terminal processing apparatus 600 to the image forming apparatus 300 is described. When the job is executed, it is beforehand understood that the terminal processing apparatus 600 is connected through the 11ah connection by the SNMP communication. The access point 500 is connected to the terminal processing apparatus 600 through the 11ah connection. Moreover, the image forming apparatus 300 is also connected to the access point 500 through the 11ah connection in order to recognize that the terminal processing apparatus 600 is connected through the 11ah connection to the access point 500.

When the job data is received through the 11ah connection in executing the print process in the step S2616 (see FIG. 26), preparation time may be longer than print time depending on data volume of job data and a communication speed of the 11ah connection. The print time is a time period required to print one page. A printer that can print 60 pages per a minute outputs one page per a second. When a time interval between pages is 0.2 second, for example, the print time becomes about 0.8 second. In the case where the preparation time is longer than print time, it is preferable to start printing after print data in a predetermined size is prepared in the DRAM 306 etc. in order to prevent a poor image from outputting due to shortage of print data during printing of one page. Although the UDP structure shown in FIG. 27A is described using the SNMP version 2 in this embodiment, another version may be used.

### Other Embodiments

Embodiment(s) of the present invention can also be realized by a computer of a system or apparatus that reads out and executes computer executable instructions (e.g., one or more programs) recorded on a storage medium (which may also be referred to more fully as ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2021-198639, filed Dec. 7, 2021, No. 2021-198638, filed Dec. 7, 2021, No. 2022-063498, filed Apr. 6, 2022, and No. 2022-141641, filed Sep. 6, 2022, which are hereby incorporated by reference herein in their entireties.

What is claimed is:

1. An information processing apparatus comprising:
a memory device that stores a set of instructions; and
at least one processor that executes the set of instructions to:
wirelessly communicate with an external apparatus by at least one of a first communication function that wireless communicates by a first wireless communication method that conforms to IEEE802.11ah and a second communication function that wirelessly communicates by a second wireless communication method of which a communication speed is higher than that of the first wireless communication method;
determine whether an electric power state of the information processing apparatus is a second electric power state in which electric power consumption is lower than a first electric power state; and
prompt a user to set switching setting that stops the second communication function and starts the first communication function in the second electric power state.

2. The information processing apparatus according to claim 1, wherein the at least one processor that executes the set of instructions to issue a notification showing that the electric power consumption can be reduced by enabling the switching setting, and wherein the notification prompts a user to set the switching setting.

3. The information processing apparatus according to claim 2, wherein the at least one processor that executes the set of instructions to control whether to issue the notification in accordance with an instruction by the user.

4. The information processing apparatus according to 1, wherein the at least one processor that executes the set of instructions to:
scan a wireless LAN access point that supports the first wireless communication method; and
display a list of SSIDs of wireless LAN access points found by scan.

5. The information processing apparatus according to claim 1,
wherein electric power consumption of wireless communication by the first communication function is lower than electric power consumption of wireless communication by the second communication function.

6. The information processing apparatus according to claim 1,
wherein a wireless frequency of the second wireless communication method is not less than 1 GHz.

7. The information processing apparatus according to claim 6, wherein the second wireless communication method conforms to at least one of standards of IEEE802.11a/b/g/n/ac/ax.

8. The information processing apparatus according to claim 1, wherein the information processing apparatus comprises an image forming apparatus that is provided with a printing unit that prints image data on a sheet and a reading unit that reads a document and generates image data of the document.

9. The information processing apparatus according to claim 8, wherein the printing unit and the reading unit are operatable in the first electric power state, and
wherein the printing unit and the reading unit are in power saving states in the second electric power state.

10. The information processing apparatus according to 1, further comprising a wireless communication unit that is provided with both the first communication function and the second communication function.

11. The information processing apparatus according to claim 1, further comprising:
a first wireless communication unit configured to have the first communication function; and
a second wireless communication unit configured to have the second communication function.

12. A control method for an information processing apparatus, the control comprising:
wirelessly communicating with an external apparatus by at least one of a first communication function that wireless communicates by a first wireless communication method that conforms to IEEE802.11ah and a second communication function that wirelessly communicates by a second wireless communication method of which a communication speed is higher than that of the first wireless communication method;
determining whether an electric power state of the information processing apparatus is a second electric power state in which electric power consumption is lower than a first electric power state; and
prompting a user to set switching setting that stops the second communication function and starts the first communication function in the second electric power state.

13. A non-transitory computer-readable storage medium storing a control program causing a computer to execute a control method for an information processing apparatus, the control method comprising:
wirelessly communicating with an external apparatus by at least one of a first communication function that wireless communicates by a first wireless communication method that conforms to IEEE802.11ah and a second communication function that wirelessly communicates by a second wireless communication method of which a communication speed is higher than that of the first wireless communication method;
determining whether an electric power state of the information processing apparatus is a second electric power state in which electric power consumption is lower than a first electric power state; and
prompting a user to set switching setting that stops the second communication function and starts the first communication function in the second electric power state.
